(19) United States
(12) Patent Application Publication
(10) Pub. No.: US 2025/0211334 A1
(43) Pub. Date: Jun. 26, 2025

(54) OPTICAL NETWORK SYSTEM, CONTROL METHOD, AND STORAGE MEDIUM

(71) Applicant: NEC Corporation, Tokyo (JP)

(72) Inventors: Shoma TATENO, Tokyo (JP); Hidemi NOGUCHI, Tokyo (JP)

(73) Assignee: NEC Corporation, Tokyo (JP)

(21) Appl. No.: 18/975,267

(22) Filed: Dec. 10, 2024

(30) Foreign Application Priority Data
Dec. 26, 2023 (JP) 2023-219597

(51) Int. Cl. H04B 10/29; H04B 10/58; H04B 10/61

(52) U.S. Cl. CPC H04B 10/29; H04B 10/58; H04B 10/6163

(57) ABSTRACT

An optical network system includes: a transmitter configured to compensate a first nonlinear distortion; a receiver configured to compensate a second nonlinear distortion; an optical repeater configured to compensate a third nonlinear distortion; and a controller configured to control the transmitter, the receiver, and the optical repeater, and determines a distortion compensation section of the optical repeater in a transmission line in which the optical repeater performs nonlinear distortion compensation.

This application is based upon and claims the benefit of priority from Japanese patent application No. 2023-219597, filed on Dec. 26, 2023, the disclosure of which is incorporated herein in its entirety by reference.

### TECHNICAL FIELD

The present disclosure relates to an optical network system, a control method, and a storage medium.

### BACKGROUND ART

In recent years, 5G wireless communication systems have been introduced, and in the post-5G era, there is a growing demand for high-capacity communication, ultra-high speed, ultra-low latency, and many simultaneous connections, not only in wireless communication but also in the field of optical communication. For this reason, research is being conducted on optical communication systems with the expectation that they will be used for various communication services and industrial applications.

For example, in backbone optical communication systems, digital coherent systems combining optical phase modulation systems and polarization multiplexing and separation technologies are used to achieve capacities in excess of 100 Gbps. In addition, research and development of transmission systems that improve frequency utilization efficiency and enable multiple simultaneous connections by narrowing the signal bandwidth and using wavelength division multiplexing (WDM) is also underway. Research and development are also being conducted on distortion compensation technology that uses optical or digital signal processing to compensate for signal distortion that occurs during optical transmission, such distortion hindering high-capacity communications due to high baud rates and high multi-level signal modulation in optical communication systems.

As a related technique, for example, Japanese Unexamined Patent Application Publication No. 2012-0224855 (Patent Document 1) is known. Patent Document 1 discloses connecting an optical phase conjugator that generates a phase conjugate signal by digital signal processing between a transmitting device and a receiving device.

In the technology related to the optical network system described above, there is a demand for suppressing degradation of signal quality due to nonlinear distortion in optical transmission.

An example object of the present disclosure is to provide an optical network system, a control method, and a program that solve the above-mentioned problems.

### SUMMARY

An optical network system according to one example embodiment of the present disclosure includes a transmitter configured to compensate a first nonlinear distortion; a receiver configured to compensate a second nonlinear distortion; one or more optical repeaters configured to compensate a third nonlinear distortion; an optical transmission line connecting the transmitter, the optical repeater, and the receiver; a controller configured to control the transmitter, the receiver, and the optical repeater; at least one memory configured to store instructions; and at least one processor configured to execute the instructions to determine a distortion compensation section of the optical repeater in a transmission line in which the optical repeater performs nonlinear distortion compensation.

An information processing method according to one example aspect of the present disclosure is a method executed by an optical network system comprising: a transmitter configured to compensate a first nonlinear distortion; a receiver configured to compensate a second nonlinear distortion; one or more optical repeaters configured to compensate a third nonlinear distortion; an optical transmission line connecting the transmitter, the optical repeater, and the receiver; and a controller configured to control the transmitter, the receiver, and the optical repeater, the method comprising: determining a distortion compensation section of the optical repeater; notifying at least one of the transmitter and the receiver of nonlinear distortion compensation information to be used for nonlinear distortion compensation in a transmission line outside the distortion compensation section of the optical repeater; generating and sending, by at least one of the transmitter and the receiver, a nonlinear distortion compensated signal based on the nonlinear distortion compensation information; and performing, by the optical repeater, nonlinear distortion compensation based on the nonlinear distortion compensation information.

A non-transitory storage medium stores a program according to one example aspect of the present disclosure, a computer of an optical network system comprising: a transmitter configured to compensate a first nonlinear distortion; a receiver configured to compensate a second nonlinear distortion; one or more optical repeaters configured to compensate a third nonlinear distortion; an optical transmission line connecting the transmitter, the optical repeater, and the receiver; and a controller configured to control the transmitter, the receiver, and the optical repeater, wherein the program causes the computer to execute determining a distortion compensation section of the optical repeater; and notifying at least one of the transmitter and the receiver of nonlinear distortion compensation information to be used for nonlinear distortion compensation in a transmission line outside the distortion compensation section of the optical repeater.

### BRIEF DESCRIPTION OF THE DRAWINGS

FIG. 1 is a diagram showing a configuration example of an optical network system according to a basic example.

FIG. 2 is a configuration diagram showing a configuration example of an optical repeater according to a basic example.

FIG. 3 is a configuration diagram showing a configuration of the optical transmitter/receiver according to the present disclosure.

FIG. 4A is a diagram for illustrating the challenges of the optical transmitter/receiver according to the present disclosure.

FIG. 4B is a diagram for illustrating the challenges of the optical transmitter/receiver according to the present disclosure.

FIG. 5 is a configuration diagram showing the outline configuration of the control system according to the present disclosure.

FIG. 6 shows an outline configuration of a transmitting terminal device according to the present disclosure.

FIG. 7 shows an outline configuration of a receiving terminal device according to the present disclosure.

FIG. 8 shows an outline configuration diagram illustrating a specific example of a nonlinear compensation portion according to the present disclosure.

FIG. 9 shows a schematic configuration of an optical repeater according to the present disclosure.

FIG. 10 is a configuration diagram showing an example configuration of an optical network system according to one example embodiment of the present disclosure.

FIG. 11 is a configuration showing a configuration example of each device in an optical network system according to one example embodiment of the present disclosure.

FIG. 12A is a conceptual diagram showing a specific example of distortion compensation section determination in an optical repeater using a control method according to an example embodiment of the present disclosure.

FIG. 12B is a conceptual diagram showing a specific example of distortion compensation section determination in an optical repeater using a control method according to an example embodiment of the present disclosure.

FIG. 13 is a configuration showing a configuration example of an optical repeater in an optical network system according to one example embodiment of the present disclosure.

FIG. 14 is a configuration diagram showing an example configuration of the chromatic dispersion compensation portion according to one example embodiment of this disclosure.

FIG. 15 is a configuration showing a configuration example of an optical repeater in an optical network system according to one example embodiment of the present disclosure.

FIG. 16 is a configuration showing a configuration example of an optical receiver in an optical network system according to one example embodiment of the present disclosure.

FIG. 17 is a flowchart showing an example of the operation of an optical network system according to one example embodiment of this disclosure.

FIG. 18A is a diagram that shows a specific example of chromatic dispersion compensation by a control method according to one example embodiment of this disclosure.

FIG. 18B is a diagram that shows a specific example of chromatic dispersion compensation by a control method according to one example embodiment of this disclosure.

FIG. 18C is a diagram that shows an overview of the phase conjugation processing according to one example embodiment of this disclosure.

FIG. 19 is a diagram that shows a specific example of chromatic dispersion compensation by a control method according to one example embodiment of this disclosure.

FIG. 20A is a conceptual diagram showing a specific example of a compensation section determination for a transmitter and a compensation section determination for a receiver according to a control method according to an example embodiment of the present disclosure.

FIG. 20B is a conceptual diagram showing a specific example of a compensation section determination for a transmitter and a compensation section determination for a receiver according to a control method according to an example embodiment of the present disclosure.

FIG. 21 is a configuration diagram showing an overview of the hardware of a computer according to an example embodiment of the present disclosure.

### EXAMPLE EMBODIMENT

Hereinafter, example embodiments of an optical network system, a control method, a control program, a control device, and an optical repeater according to the present disclosure will be described with reference to the drawings. In each drawing, identical elements are denoted by the same reference numerals, and duplicate explanations are omitted where necessary. Note that arrows added to the configuration diagrams (block diagrams) are for illustrative purposes only and do not limit the type or direction of signals.

### Considerations Leading to the Example Embodiment

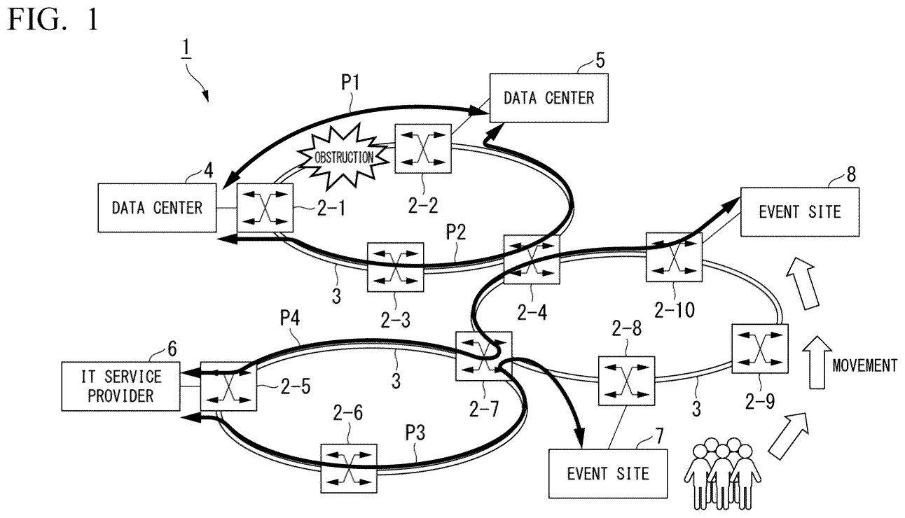

FIG. 1 shows the configuration of an optical network system according to the basic example serving as the basis of the present example embodiment. An optical network system 1 according to the basic example is, for example, a backbone wavelength-division multiplexing optical transmission system, and achieves high-capacity communication of over 100 Gbps by the devices comprising the system performing wavelength multiplexing of optical signals, as well as high-level modulation and digital coherent transmission with optical signals at different wavelengths. High-density wavelength division multiplexing enables improved optical frequency utilization efficiency, allowing the system to handle mobile traffic and wavelength defragmentation.

The optical network system 1 is provided with optical repeaters 200 (e.g., 2-1 to 2-10) that can flexibly switch transmission lines (wavelength paths or optical transmission lines) while maintaining the optical signals in order to accommodate switching of transmission lines in case of failure or to meet local traffic demand (e.g., traffic demand for communications from networks of data centers 4 and 5, the network of an IT service provider 6, and networks of event venues 7 and 8). The optical network system 1 can maintain communication via optical signals as infrastructure by including the optical repeaters 200 (e.g., 2-1 to 2-10).

The optical repeater 200 is a photonic node capable of repeating wavelength-multiplexed optical signals, and is, for example, a reconfigurable optical add/drop multiplexer (ROADM) device. Each optical repeater 200 is assigned a wavelength path (also referred to simply as a path), and forwards traffic of the local network and other optical repeaters 200 accommodated via optical communication cables that pass optical signals of the assigned wavelength path to the destination network or other communication devices.

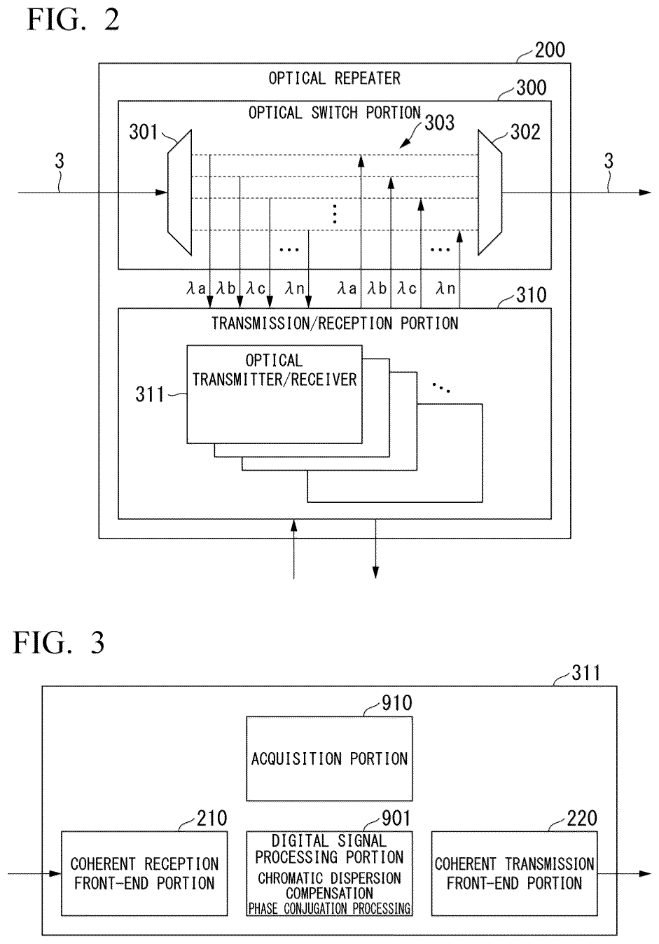

FIG. 2 shows a configuration example of the optical repeater 200 according to a basic example. The optical repeater 200 branches/inserts optical wavelength multiplex signals and coherently modulates and demodulates the signals of each wavelength subject to branching/insertion. As shown in FIG. 2, the optical repeater 200 is provided with an optical switch portion 300 and a transmission/reception portion 310.

The optical switch portion 300 forwards optical signals of a given wavelength path received from the front-stage optical repeater 200 in the optical network system 1 to the rear-stage optical repeater 200, and also branches/inserts the received optical signals by wavelength. For example, the optical switch portion 300 is provided with a demultiplexer 301, a multiplexer 302, and a branching/insertion portion 303. The demultiplexer 301 separates an optical signal received from the optical transmission line 3 into optical signals of multiple wavelengths. The multiplexer 302 combines optical signals of multiple wavelengths into a single optical signal and transmits it to the optical transmission line 3. The branching/insertion portion 303 branches/inserts optical signals of each wavelength between the demultiplexer 301 and the multiplexer 302.

The transmission/reception portion 310 (transponder) receives optical signals of each wavelength branched from the branching/insertion portion 303 of the optical switch portion 300 and outputs coherently demodulated received data to the local device (network) that accommodates it. The transmission/reception portion 310 inputs transmission data from the local device and transmits (inserts) optical signals of each wavelength that have been coherently modulated to the branching/insertion portion 303 of the optical switch portion 300. The transmission/reception portion 310 is equipped with a plurality of optical transmitters/receivers 311 that transmit and receive optical signals at various wavelengths. Each optical transmitter/receiver 311 receives optical signals of a predetermined wavelength and further transmits optical signals of a predetermined wavelength (the same or different wavelength from the received wavelength) to the destination.

The issues that arise in a case where using an optical transmitter/receiver as the optical transmitter/receiver 311 shall be discussed here. FIG. 3 shows an example configuration of an optical transmitter/receiver according to this disclosure. As shown in FIG. 3, the optical transmitter/receiver 311 according to this disclosure is provided with a coherent reception front-end portion 210, a coherent transmission front-end portion 220, an acquisition portion 910, and a digital signal processing portion 901. Digital signal processing enables phase conjugation processing, chromatic dispersion compensation, and phase rotation processing on a per-channel basis.

The coherent reception front-end portion 210 performs coherent detection of the optical signal received from the optical repeater 200 in the previous stage using local oscillator (LO) light of a predetermined wavelength and outputs the detected signal to the digital signal processing portion 901. The coherent transmission front-end portion 220 optically modulates the signal processed by the digital signal processing portion 901 to a predetermined wavelength (coherent modulation) and transmits the generated optical signal to the optical repeater 200 of the next stage. The digital signal processing portion 901 is a digital signal processor (DSP) that converts the signal detected coherently by the coherent reception front-end portion 210 into a digital signal, outputs the processed received data, replays the input transmission data, and outputs the signal converted for optical modulation to the coherent transmission front-end portion 220. In this disclosure, phase conjugation processing, chromatic dispersion compensation, and phase rotation processing are performed on a per-channel basis in the digital signal processing portion 901.

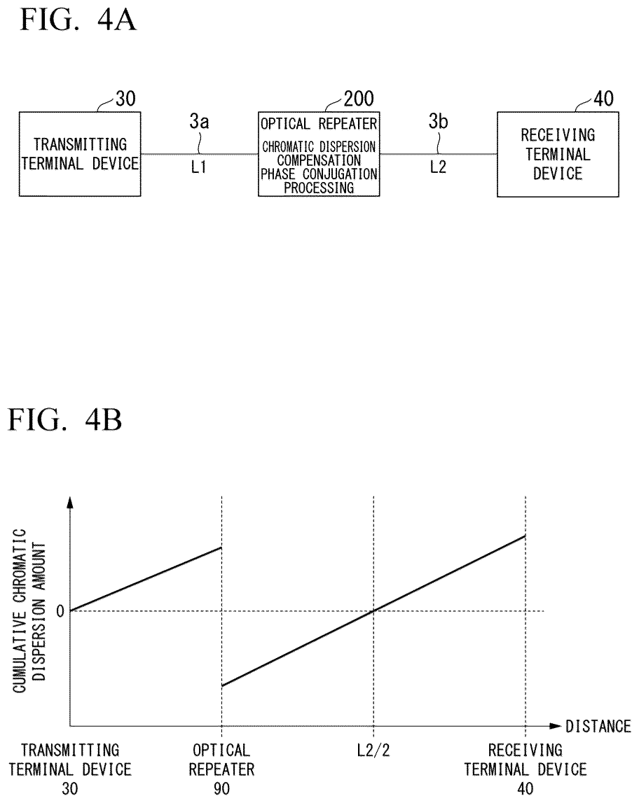

FIG. 4A and FIG. 4B show the chromatic dispersion amount in a case where using an optical repeater 200 including the optical transmitter/receiver 311 of this disclosure. As shown in FIG. 4A, the optical repeater 200 is connected between the transmitting terminal device (transmitting end) 30 and the receiving terminal device (receiving end) 40 via optical transmission lines 3a and 3b. The optical transmission line 3a includes distance L1 and optical transmission line 3b includes distance L2, and L1 and L2 may be the same length or different. Optical signals of wavelength λ1 are transmitted in the optical transmission line 3a, and optical signals of wavelength λ2 are transmitted in the optical transmission line 3b. Although the optical transmission lines 3a and 3b illustrated in FIG. 4A each include one transmission line section, they may each include multiple transmission line sections accompanied by signal amplification. Note that one transmission line section refers to a section of a transmission line between two adjacent network devices that are communicatively connected, such as optical repeaters and optical signal amplifiers that are connected in a communication network.

In a configuration in which the optical repeater 200 is connected to the path from the transmitting terminal device 30 to the receiving terminal device 40 as shown in FIG. 4A, the side closer to the transmitting terminal device 30 than the optical repeater 200 may be called the first stage of the optical repeater 200 (the reception side of optical signals) while the side closer to the receiving terminal device 40 than the optical repeater 200 may be called the second stage of the optical repeater (the transmission side of optical signals). The optical transmission line between the optical repeater 200 and the transmitting terminal device 30 may be referred to as the front-stage (first portion) optical transmission line, and the optical transmission line between the optical repeater 200 and the receiving terminal device 40 as the rear-stage (second portion) optical transmission line.

As shown in FIG. 4B, the chromatic dispersion amount increases in proportion to the distance of the optical transmission line. Therefore, if the optical repeater 200 relays optical signals only by mere signal amplification, the chromatic dispersion amount continues to increase with distance from the transmitting terminal device 30 to the receiving terminal device 40. Then, as the distance of the optical transmission line increases, the quality of the optical signal received at the receiving terminal device 40 deteriorates significantly. In addition to chromatic dispersion, nonlinear distortion also causes significant degradation of optical signal quality. Nonlinear distortion is a phenomenon in which the phase of light itself changes due to a change in the refractive index in the material in proportion to the optical signal intensity as the optical signal propagates through the optical fiber. Such nonlinear distortion is a limiting factor for high-capacity and long-distance transmission of optical signals due to high baud rate and high multi-level transmission.

In the example disclosed above, in a case where the optical repeater 200 connected to the path from the transmitting terminal device 30 to the receiving terminal device 40 receives optical signals including one or more optical channels, the optical repeater 200 performs phase conjugation processing and equivalent digital signal processing of chromatic dispersion compensation for each channel received. In the example disclosed above, in the optical repeater 200, the nonlinear distortion generated in the transmission path of the front stage and the nonlinear distortion generated in the transmission path of the rear stage are canceled by performing phase conjugation processing and chromatic dispersion compensation, whereby the effect of nonlinear distortion at the receiving terminal device 40, which is the receiving end, can be mitigated.

In the example disclosed above, in a case where the optical repeater 200 is located halfway between the transmitting terminal device 30 and the receiving terminal device 40, that is, in a case where the distance L1 of the optical transmission line 3a between the transmitting terminal device 30 (transmitting device) and the optical repeater 200 is equal to the distance L2 of the optical transmission line 3b between the optical repeater 200 and the receiving terminal device 40 (receiving device), the range of nonlinear distortion caused by the repeater extends over the entire transmission line, and nonlinear distortion can be most effectively mitigated. Since the position of the optical repeater 200 in the actual optical network system 1 can be arbitrarily placed, it is desirable to ensure that the nonlinear distortion compensation effect can be fully obtained even in a case where the optical repeater 200 is not located halfway between the transmitting terminal device 30 and the receiving terminal device 40. In the present disclosure, by using an optical repeater 200, a transmitting terminal device 30 having a nonlinear compensation portion 34, a receiving terminal device 40 having a nonlinear compensation portion 44, and a control device 10 having a management portion that controls the nonlinear compensation portions 34, 44, it is possible to mitigate nonlinear distortion of a signal in a transmission line even in a case where the optical repeater 200 is not located halfway between the transmitting terminal device 30 and the receiving terminal device 40.

The outline of the present example embodiment will be described. The optical network system 1 is shown, which is composed of the transmitting terminal device 30 having the nonlinear compensation portion 34, one or more optical repeaters 200 having the nonlinear compensation portion 44, the receiving terminal device 40 having the nonlinear compensation portion 44, an optical transmission line connecting them, and the control device 10 having a management portion that controls the nonlinear compensation portions 34, 44. Processing units similar to the nonlinear compensation portions 34, 44 may be provided in the transmitting device and the receiving device that constitute the optical network system and are located on either side of the optical repeater 200. The transmitting device or the receiving device may be an optical signal amplifier 50 provided in the transmission line. In the example embodiment of the present disclosure, an optical repeater having a nonlinear distortion compensation portion that performs phase conjugation and chromatic dispersion compensation processing is shown. In other words, the nonlinear distortion compensation process in the optical repeater 200 of the present disclosure is a process of phase conjugation and a process of chromatic dispersion compensation. Similarly, nonlinear distortion compensation processing can be performed in an optical repeater configuration that performs phase rotation processing.

### Overview of the Example Embodiment

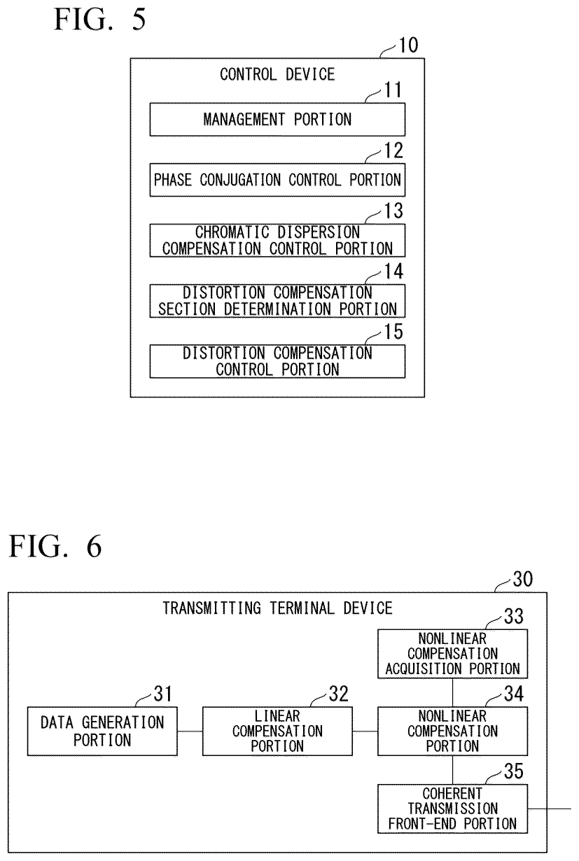

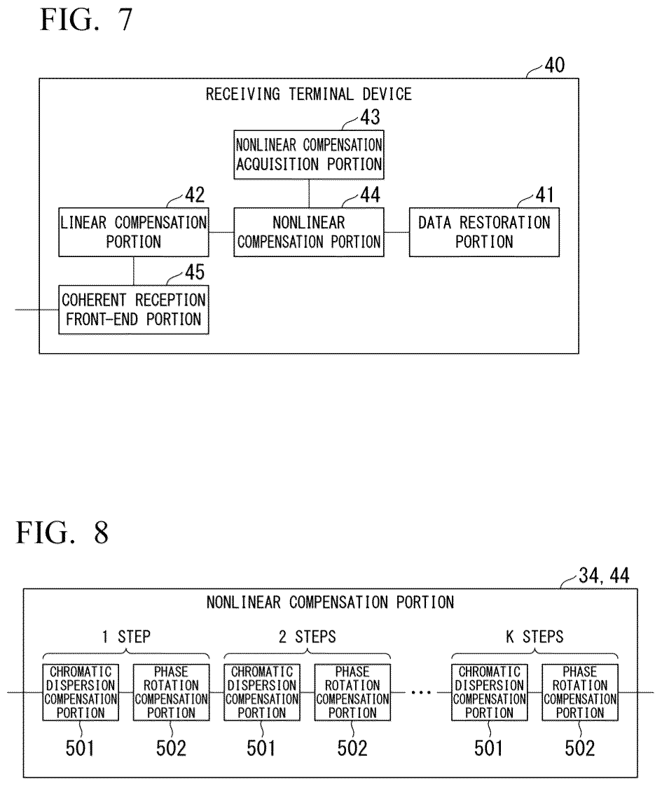

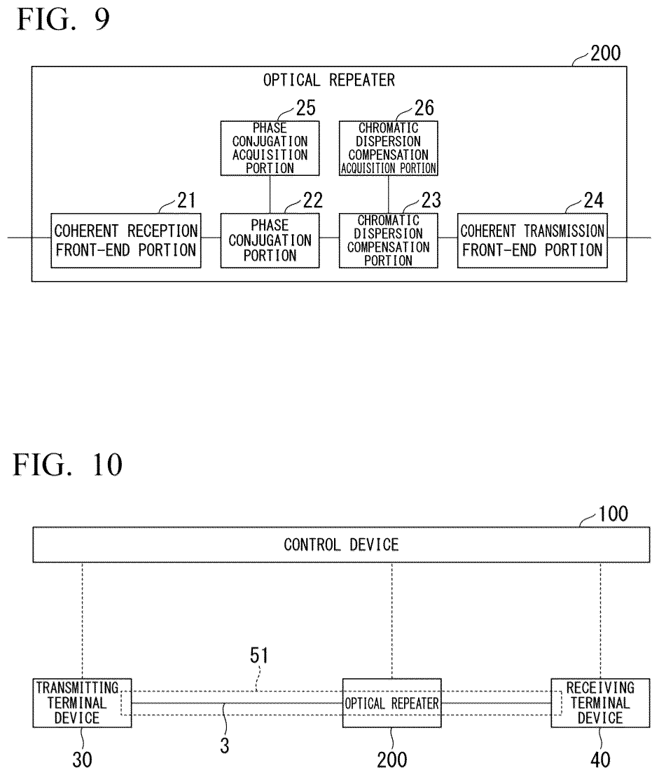

FIG. 5 shows an outline configuration of the control device according to the present example embodiment. FIG. 6 shows an outline configuration of the transmitting terminal device according to the present example embodiment. FIG. 7 shows an outline configuration of the receiving terminal device according to the present example embodiment. FIG. 8 is a conceptual diagram showing a specific example of the nonlinear compensation portion according to the present example embodiment. FIG. 9 shows an outline configuration of the optical repeater according to the present example embodiment.

The control device 10, the optical transmitter 30, the optical repeater 200, and the optical receiver 40 are included in the optical network system 1. The transmitting terminal device 30 of the present example embodiment is included in part of the optical network system 1, the optical repeater 200 of the present example embodiment is included in part of the optical network system 1, the receiving terminal device 40 of the present example embodiment is included in part of the optical network system 1, and the control device 10 of the present example embodiment controls the other components in the optical network system 1, that is, the transmitting terminal device 30, the optical repeater 200, and the receiving terminal device 40.

As shown in FIG. 5, the control device 10 includes a management portion 11, a phase conjugation control portion 12, a chromatic dispersion compensation control portion 13, a distortion compensation section determination portion 14, and a distortion compensation control portion 15. The management portion 11 manages transmission line information of optical transmission lines connected to one or more optical repeater devices 200 in a path of an optical network, and the carrier frequency (wavelength) of each channel of an optical signal including one or more signal channels received by the optical repeater 200. The phase conjugation control portion 12 determines the phase conjugation processing in the optical repeater 200 based on the transmission line information and carrier frequency information managed by the management portion 11. The chromatic dispersion compensation control portion 13 determines the amount of chromatic dispersion compensation to be performed in the optical repeater 200 based on the transmission line information and carrier frequency managed by the management portion 11. The distortion compensation section determination portion 14 determines a distortion compensation section, which is a transmission line for which the optical repeater in the transmission line of the optical network system 1 performs nonlinear distortion compensation. The distortion compensation control portion 15 controls the nonlinear distortion compensation processing of the transmitting terminal device 30 and the receiving terminal device 40 based on the information on the distortion compensation section determined by the distortion compensation section determination portion 14. Note that nonlinear distortion compensation or nonlinear distortion compensation processing may be simply referred to as distortion compensation processing or compensation processing.

As shown in FIG. 6, the transmitting terminal device 30 (transmitting device) is provided with a data generation portion 31, a linear compensation portion 32, a nonlinear compensation acquisition portion 33, a nonlinear compensation portion 34, and a coherent transmission front-end portion 35. The nonlinear compensation acquisition portion 33 acquires from the control device 10 the nonlinear distortion compensation information determined by the distortion compensation control portion 15 and used by the transmitting device. The nonlinear compensation portion 34 performs nonlinear distortion compensation processing based on the nonlinear distortion compensation information acquired from the nonlinear compensation acquisition portion 33. Although not shown in FIG. 6, the transmitting terminal device 30 generates a plurality of optical channels, and transmits a multiplexed optical signal as a transmission signal to a transmission line.

As shown in FIG. 7, the receiving terminal device 40 (receiving device) is provided with a data restoration portion 41, a linear compensation portion 42, a nonlinear compensation acquisition portion 43, a nonlinear compensation portion 44, and a coherent reception front-end portion 45. The nonlinear compensation acquisition portion 43 acquires from the control device 10 the nonlinear distortion compensation information determined by the distortion compensation control portion 15 and used by the transmitting device. The nonlinear compensation portion 44 performs nonlinear distortion compensation processing based on the nonlinear distortion compensation information acquired from the nonlinear compensation acquisition portion 43. Although not shown in FIG. 7, the receiving terminal device 40 receives and demultiplexes a plurality of optical channels and performs signal processing on the optical signals of each channel.

One example of nonlinear distortion compensation processing is the digital backpropagation (DBP) method. The digital backpropagation method is a method for achieving nonlinear distortion compensation by simulating nonlinear waveform distortion in an optical fiber communication channel using digital signal processing and applying the inverse effect of the nonlinear waveform distortion to transmitted or received data.

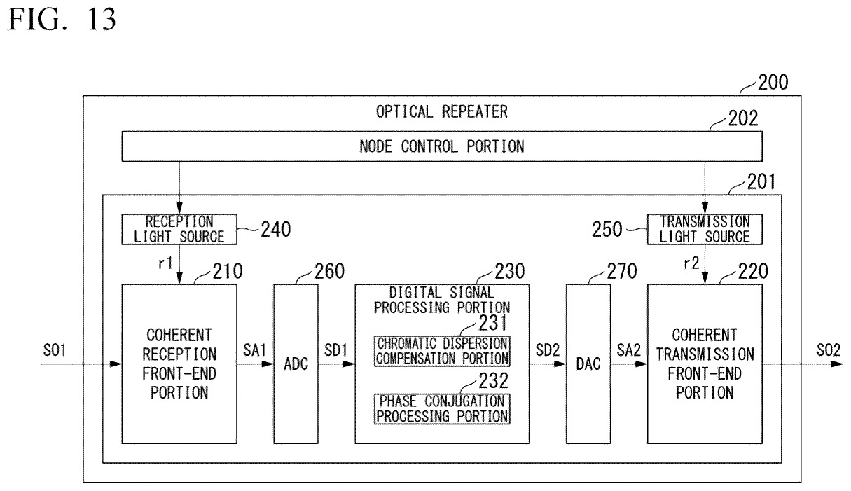

As shown in FIG. 8, the nonlinear compensation portion 34 in the transmitting terminal device 30 and the nonlinear compensation portion 44 in the receiving terminal device 40 each include a chromatic dispersion compensation portion 501 and a phase rotation compensation portion 502. In the digital back-propagation method, one step including the chromatic dispersion compensation portion 501 (corresponding to a chromatic dispersion compensation portion 231 in FIG. 13), which includes a Fast Fourier Transform (FFT), a frequency response multiplication based on the wavelength dispersion compensation amount in that step, and an Inverse Fast Fourier Transform (IFFT), and the phase rotation compensation portion 502 that performs phase rotation of a relevant symbol based on nonlinear distortion compensation information including information between the relevant symbol and symbols before and after the relevant symbol in the time domain (number of taps and symbol weight coefficients) and fixed coefficients (nonlinear coefficients) is made up of K steps (where K is n integer greater than or equal to 1). The nonlinear distortion compensation information may be determined for each step. The chromatic dispersion compensation portion 501 and the phase rotation compensation portion 502 perform nonlinear distortion compensation on the signal based on the information acquired from the nonlinear compensation acquisition portion 33 or 43. The nonlinear distortion compensation information described above in the description of FIG. 6 includes, for example, the number of steps used in the nonlinear distortion compensation process configured by the nonlinear compensation portions 34 and 44 shown in FIG. 8, the amount of chromatic dispersion in the chromatic dispersion compensation portion 501 at each step, the number of taps and symbol weighting coefficients related to the phase rotation compensation portion 502, and nonlinear parameters.

As shown in FIG. 9, the optical repeater 200 is provided with a coherent reception front-end portion 21, a phase conjugation portion 22, a chromatic dispersion compensation portion 23, a coherent transmission front-end portion 24, a phase conjugation acquisition portion 25, and a chromatic dispersion compensation acquisition portion 26. Although not shown in FIG. 9, multiple optical channels are transmitted and received, and phase conjugation and chromatic dispersion compensation are performed for each channel signal.

Returning to the explanation of FIG. 5, the phase conjugation acquisition portion 25 acquires phase conjugation processing information determined by the phase conjugation control portion 12 of the control device 10. The chromatic dispersion compensation acquisition portion 26 acquires the chromatic dispersion compensation amount determined by the chromatic dispersion compensation control portion 13 of the control device 10. The coherent reception front-end portion 21 performs coherent detection of the received optical signal based on the local oscillator light of the reception carrier frequency obtained from the management portion 11 and outputs a coherently detected electrical signal. The phase conjugation portion 22 performs phase conjugation processing by digital signal processing on the electrical signal output from the coherent reception front-end portion 21 based on the phase conjugation processing settings acquired by the phase conjugation acquisition portion 25. The chromatic dispersion compensation portion 23 performs chromatic dispersion compensation processing by digital signal processing on the electrical signal output from the phase conjugation portion 22 based on the chromatic dispersion compensation amount acquired by the chromatic dispersion compensation acquisition portion 26. The coherent transmission front-end portion 24 performs coherent modulation on the electrical signal subject to phase conjugation processing by the phase conjugation portion 22 and the electrical signal subject to chromatic dispersion compensation processing by the chromatic dispersion compensation portion 23 based on the local oscillator light of the transmission carrier frequency acquired from the management portion 11, and transmits the coherently modulated optical signal.

By performing phase conjugation of optical signals with the optical repeater 200, it is possible to invert the distortion of the optical signal in the front-stage optical transmission line of the optical repeater 200. As the signal propagates through the rear-stage optical transmission line of the optical repeater 200, the distortion is reverse-reproduced and offset at the receiving end (receiving terminal device 40, etc.). Since the example embodiment described below enables chromatic dispersion compensation with appropriate phase conjugation and a chromatic dispersion compensation amount in the optical repeater 200, using the phase conjugation and chromatic dispersion compensation at each optical repeater 200 in a multi-span optical network, it is possible to maximize the cancellation effect of nonlinear distortion caused by multi-span optical transmission, enabling the effective suppression of degradation of signal quality due to nonlinear distortion at the receiving end of the optical network.

In nonlinear distortion compensation using distortion cancellation using phase conjugation and chromatic dispersion compensation by the optical repeater 200, there are sections that the optical repeater 200 cannot compensate unless the optical repeater 200 is located at the center of the transmission path between the transmitting terminal device 30 and the receiving terminal device 40. Therefore, the control portion 10 determines the distortion compensation section, which is the transmission line for which the optical repeater 200 performs nonlinear distortion compensation, and for sections of other transmission lines (outside the distortion compensation section) that are not the transmission line for which the optical repeater 200 performs nonlinear distortion compensation (sections that the optical repeater 200 cannot compensate), performs nonlinear distortion compensation at the transmitting terminal device 30 or the receiving terminal device 40 based on the nonlinear distortion compensation information used by the transmitting terminal device 30 and the receiving terminal device 40 determined by the control portion 10. This makes it possible to effectively reduce nonlinear distortion regardless of the position of the optical repeater 200 on the transmission line between the transmitting terminal device 30 and the receiving terminal device 40.

Thus, in this example embodiment, the control device 10 determines the phase conjugation processing and the amount of chromatic dispersion compensation in the optical repeater 200 based on wavelength information and signal bandwidth information of optical signals transmitted and received by the optical repeater 200 in the transmission line between the transmitting terminal device 30 and the receiving terminal device 40, and transmission line information of the optical transmission line connected to the optical repeater 200. The control device 10 performs the determined phase conjugation processing and chromatic dispersion compensation of the chromatic dispersion compensation amount for compensation of nonlinear distortion in the optical repeater 200. The control device 10 determines the distortion compensation section of the optical repeater based on transmission line information of the optical transmission line connected to the optical repeater 200 and position information of the optical repeater. The control device 10 determines nonlinear distortion compensation information to be used by the transmitting terminal device 30 and the receiving terminal device 40 for nonlinear distortion compensation processing, based on the distortion compensation section of the optical repeater 200. The control device 10 notifies the transmitting terminal device 30 or the receiving terminal device 40 of nonlinear distortion compensation information used by the transmitting terminal device 30 and the receiving terminal device 40. The control device 10 performs nonlinear distortion compensation in at least one of the transmitting terminal device 30 and the receiving terminal device 40 based on the nonlinear distortion compensation information notified from the control device 10. As described above, the nonlinear distortion compensation performed by the optical repeater 200 includes phase conjugation processing and chromatic dispersion compensation processing. Moreover, the nonlinear distortion compensation performed by the transmitting terminal device 30 or the receiving terminal device 40 includes signal processing using the digital back-propagation method.

### Example Embodiment 1

Next, Example Embodiment 1 shall be explained with reference to the drawings. FIG. 10 illustrates a configuration example of an optical network system 1 according to an example embodiment of the present disclosure. As shown in FIG. 10, an optical network system 1 in accordance with one example embodiment of the present disclosure is provided with a control device 100, the optical repeater 200, the transmitting terminal device 30, and the receiving terminal device 40. As shown in FIG. 10, the first example embodiment shows a case where there is one optical repeater 200, but the same applies in a case where a plurality of optical repeaters 200 exist between the transmitting terminal device 30 and the receiving terminal device 40 of the optical network system 1.

The optical repeater 200, the transmitting terminal device 30, and the receiving terminal device 40 are connected to each other via optical transmission lines 3 to enable optical communication. The optical repeater 200, the transmitting terminal device 30, the receiving terminal device 40, and the control device 100 are connected to enable communication of control signals. The optical repeater 200, the transmitting terminal device 30, the receiving terminal device 40 and the control device 100 may be connected via the optical transmission lines 3 or may be communicatively connected by any other transmission line, including wired or wireless.

The optical repeater 200, the transmitting terminal device 30, and the receiving terminal device 40 are optical transmission devices (optical nodes) that perform optical communications via the optical transmission lines 3. The transmitting terminal device 30 constitutes the transmitting end in a path configured by the connection of multiple optical transmission paths 3. The receiving terminal device 40 constitutes the receiving end in a path configured by the connection of multiple optical transmission lines 3. The transmitting terminal device 30 transmits a multi-channel optical signal wavelength-multiplexed by the wavelength of the path set by the control device 100 to the receiving terminal device 40 via the optical transmission line 3, as in the basic example. The receiving terminal device 40 receives, from the transmitting terminal device 30 via the optical transmission line 3, a multi-channel optical signal wavelength-multiplexed by the wavelength of the path set by the control device 100, as in the basic example.

The optical repeater 200 is a repeater that can relay wavelength-multiplexed multi-channel optical signals, as in the basic example. The optical repeater 200 constitutes an optical network 51 that performs WDM communication. It can also be said that the optical repeater 200, together with the transmitting terminal device 30 and the receiving terminal device 40, constitutes the optical network 51. The optical network 51 is a wavelength-division multiplexed optical network, as in FIG. 1. The optical network 51 can be a mesh-shaped network, ring-shaped network, point-to-point, or other topology. The optical repeater 200 configures a path from the transmitting terminal device 30 to the receiving terminal device 40 in accordance with the control from the control device 100, and transmits optical signals (data) according to wavelength set on the route of the path.

The control device 100 manages and controls the optical network 51 including the optical repeater 200. For example, the control device 100 is a network management system (NMS) that manages a network.

The control device 100 manages and controls the paths configured by the optical repeater 200 in the optical network 51. The control device 100 manages the path route and wavelengths from the transmitting terminal device 30 to the receiving terminal device 40, and sets the path route and wavelengths etc. for the transmitting terminal device 30, the receiving terminal device 40 and the optical repeater 200 on the path.

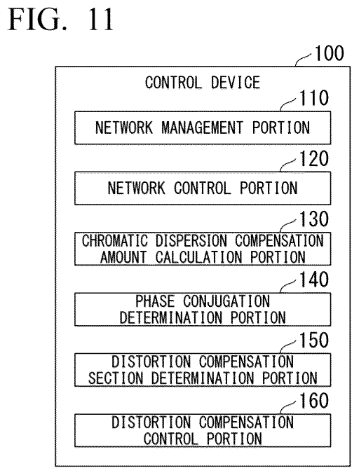

FIG. 11 illustrates a configuration example of the control device 100 in an optical network system according to an example embodiment of the present disclosure. As shown in FIG. 11, the control device 100 is provided with a network management portion 110, a network control portion 120, a chromatic dispersion compensation amount calculation portion 130, a phase conjugation determination portion 140, a distortion compensation section determination portion 150, and a distortion compensation control portion 160.

The network management portion 110 corresponds to the management portion 11 shown in FIG. 5 and manages information necessary for network management, such as network configuration information and path configuration information in the optical network 51, and position information of the optical repeater 200, etc. For example, the network management portion 110 may include a database that stores information necessary for network management. The network configuration information includes the connection relationship among the optical repeaters 200, transmitting terminal device 30, and receiving terminal device 40 that comprise the network, as well as transmission line information for the optical transmission lines 3 that connect the devices. The transmission line information includes the distance L (transmission line length) of the optical transmission line, the carrier frequency of each channel of an optical signal composed of multiple channels in the path, and may also include the structure and type of the optical fiber, transmission characteristics, and the like. The path configuration information includes information on each device comprising the path, the wavelengths available to each device on the route of the path, and the usage status of the wavelengths. These pieces of information may be set in a database in advance, or may be set by information collected from each device, and may also be updated by the network control portion 120 and the like.

The network control portion 120 corresponds to the management portion 11 shown in FIG. 5, and controls the paths in the optical network 51 and the optical repeaters 200, the transmitting terminal device 30, and the receiving terminal device 40 that comprise the paths. The network control portion 120 refers to the network configuration information, path configuration information, and the like in the network management portion 110, determines the route of the paths from the transmitting terminal device 30 to the receiving terminal device 40, and sets the determined route to the transmitting terminal device 30, receiving terminal device 40, and optical repeaters 200 on the route of the paths. The network control portion 120 determines the carrier frequency of each channel of an optical signal in the path from the transmitting terminal device 30 to the receiving terminal device 40, and sets the determined carrier frequency to the transmitting terminal device 30, the receiving terminal device 40 and optical repeaters 200 on the route of the path. The carrier frequency of the light in a path is determined for each optical transmission path in the route of the path. The network control portion 120 outputs the information necessary to calculate the chromatic dispersion compensation amount in the optical repeaters 200 that constitute the path to the chromatic dispersion compensation amount calculation portion 130. For example, the network control portion 120 outputs transmission line information for the front and rear optical transmission lines. The network control portion 120 outputs the phase conjugation determination information in the optical repeater 200 that constitutes the path to the phase conjugation determination portion 140. For example, the network control portion 120 outputs the number of paths and the number of optical repeaters in the optical network 51.

The phase conjugation determination portion 140 controls the phase conjugation processing of the optical repeaters 200 that comprise the path, corresponding to the phase conjugation control portion 12 shown in FIG. 5. The phase conjugation determination portion 140 determines the optimal phase conjugation processing for the optical repeater 200 based on the number of paths and number of optical repeaters in the optical network 51 acquired from the network control portion 120, position information of the optical repeater 200, and the like. The phase conjugation determination portion 140 notifies the optical repeater 200 of the phase conjugation processing information.

The chromatic dispersion compensation amount calculation portion 130 calculates the chromatic dispersion compensation amount for the optical repeater 200 comprising the path to perform chromatic dispersion compensation, corresponding to the chromatic dispersion compensation control portion 13 shown in FIG. 5. The chromatic dispersion compensation amount calculation portion 130 is a compensation control portion that determines and controls the chromatic dispersion compensation amount of each optical repeater 200. The chromatic dispersion compensation amount calculation portion 130 determines the optimal chromatic dispersion compensation amount for the optical repeater 200 based on the reception wavelength information, signal bandwidth, transmission wavelength information, and transmission line information before and after the optical repeater 200 acquired from the network control portion 120. The chromatic dispersion compensation amount calculation portion 130 notifies the relevant optical repeater 200 of the reception wavelength information, transmission wavelength information, and optimal chromatic dispersion compensation amount of the optical repeater 200.

The distortion compensation section determination portion 150 corresponds to the distortion compensation section determination portion 14 shown in FIG. 5, and determines a nonlinear distortion compensation section (distortion compensation section) which is a transmission line for which nonlinear distortion compensation is performed by the optical repeater 200 in the optical network 51.

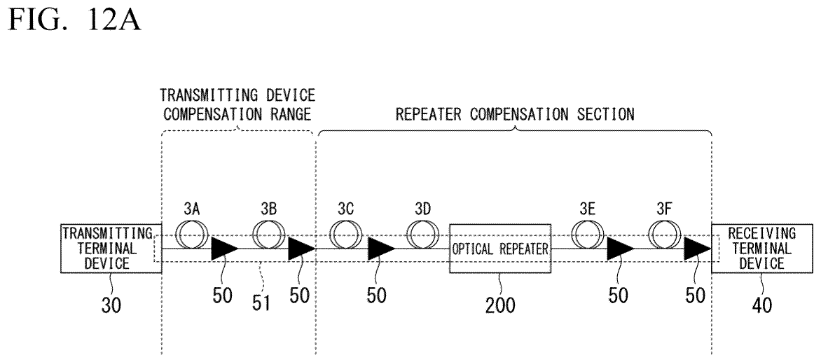

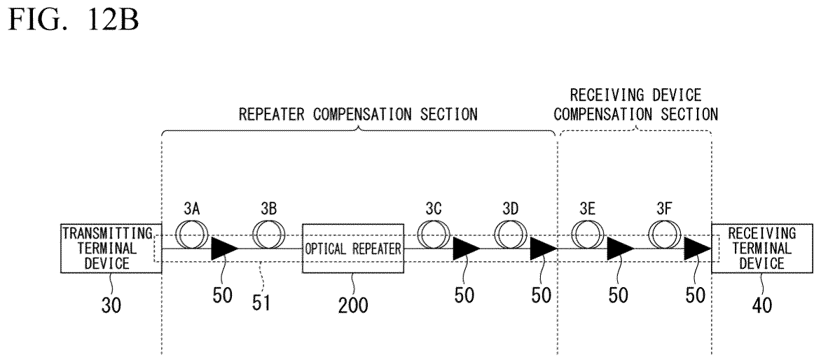

FIG. 12A is a first diagram showing the concept of a distortion compensation section determination method performed by the distortion compensation section determination portion 150. The optical transmission line connecting the transmitting terminal device 30 and the receiving terminal device 40 is composed of six transmission line sections (3A, 3B, 3C, 3D, 3E, 3F), and the optical network 51 is assumed that is composed of five optical signal amplifiers 50, each of which compensates for the transmission loss of one transmission line section, one optical repeater 200, the transmitting terminal device 30, and the receiving terminal device 40. As shown in FIG. 12A, the transmission lines in the optical network 51 are connected in the order of 3A, 3B, 3C, 3D, 3E, and 3F. It is assumed that the lengths of the transmission lines are approximately the same. The optical repeater 200 is located in the latter half from the center of the entire transmission path connecting the transmitting terminal device 30 and the receiving terminal device 40. For example, assume that the optical repeater 200 is located between the transmission lines 3D and 3E as shown in FIG. 12A. At this time, the optical repeater 200 performs nonlinear distortion compensation taking into account the nonlinear distortion occurring in the transmission line sections 3A, 3B, 3C, and 3D, and the nonlinear distortion occurring in the subsequent transmission lines 3E and 3F, so that distortion is not generated in the signal received by the receiving terminal device 40. However, as will be described in detail later, in a case where the optical repeater 200 is positioned approximately in the center between the upstream and downstream transmission paths, it can perform nonlinear distortion compensation so that no distortion occurs in the signal received by the receiving terminal device 40. Therefore, among the transmission lines 3A, 3B, 3C, 3D, 3E, and 3F, the upstream transmission lines 3C and 3D and the downstream transmission lines 3E and 3F are determined as distortion compensation sections with the position of the optical repeater 200 as the center. That is, the distortion compensation section determination portion 150 determines the number of transmission line sections in which nonlinear distortion is cancelled out in the front and rear halves of the optical repeater 200 by phase conjugation to be four, and determines the distortion compensation sections of the optical repeater 200 to be 3C to 3F. In this case, the distortion compensation section determination portion 150 determines that the transmission line sections 3A and 3B, which were not determined to be distortion compensation sections of the optical repeater 200, are the distortion compensation sections of the transmitting terminal device 30 close to those transmission lines.

FIG. 12B is a second diagram showing the concept of the distortion compensation section determination method performed by the distortion compensation section determination portion 150. The optical transmission line connecting the transmitting terminal device 30 and the receiving terminal device 40 is composed of six transmission line sections (3A, 3B, 3C, 3D, 3E, 3F), and the optical network 51 is assumed that is composed of five optical signal amplifiers 50, each of which compensates for the transmission loss of one transmission line section, one optical repeater 200, the transmitting terminal device 30, and the receiving terminal device 40. As shown in FIG. 12A, the transmission lines in the optical network 51 are connected in the order of 3A, 3B, 3C, 3D, 3E, and 3F. It is assumed that the lengths of the transmission lines are approximately the same. The optical repeater 200 is located in the middle to the front half of the entire transmission path connecting the transmitting terminal device 30 and the receiving terminal device 40. For example, assume that the optical repeater 200 is located between the transmission lines 3B and 3C as shown in FIG. 12B. At this time, the optical repeater 200 performs nonlinear distortion compensation taking into account the nonlinear distortion occurring in the transmission line sections 3A and 3B, and the nonlinear distortion occurring in the subsequent transmission lines 3C, 3D, 3E, and 3F, so that distortion is not generated in the signal received by the receiving terminal device 40. However, as will be described in detail later, in a case where the optical repeater 200 is positioned approximately in the center between the upstream and downstream transmission paths, it can perform nonlinear distortion compensation so that no distortion occurs in the signal received by the receiving terminal device 40. Therefore, among the transmission lines 3A, 3B, 3C, 3D, 3E, and 3F, the upstream transmission lines 3A and 3B and the downstream transmission lines 3C and 3D are determined as distortion compensation sections with the position of the optical repeater 200 as the center. That is, the distortion compensation section determination portion 150 determines the number of transmission line sections in which nonlinear distortion is cancelled out in the front and rear halves of the optical repeater 200 by phase conjugation to be four, and determines the distortion compensation sections of the optical repeater 200 to be 3A to 3D. In this case, the distortion compensation section determination portion 150 determines that the transmission line sections 3E and 3F, which were not determined to be distortion compensation sections of the optical repeater 200, are the distortion compensation sections of the receiving terminal device 40 close to those transmission lines.

The distortion compensation control portion 160 corresponds to the distortion compensation control portion 15 shown in FIG. 5, and controls the distortion compensation processing of the transmitting terminal device 30 or the receiving terminal device 40 based on the information of the distortion compensation section of the optical repeater determined by the distortion compensation section determination portion 150.

In the example of FIG. 12A, since the section outside the distortion compensation section of the optical repeater 200 exists in the first half of the entire transmission path, the distortion compensation control portion 160 notifies the transmitting terminal device 30 of nonlinear distortion compensation information in the distortion compensation section of the transmitting device with the transmission lines 3A and 3B serving as sections in which the transmitting terminal device 30 performs distortion compensation (distortion compensation sections of the transmitting terminal device 30), and controls the nonlinear distortion compensation portion 34.

In the example of FIG. 12B, since the section outside the distortion compensation section of the optical repeater 200 exists in the latter half of the entire transmission line, the distortion compensation control portion 160 notifies the receiving terminal device 40 of nonlinear distortion compensation information in the distortion compensation section of the receiving terminal device 40 with the transmission lines 3E and 3F serving as sections in which the receiving terminal device 40 performs distortion compensation (distortion compensation sections of the receiving terminal device 40), and controls the nonlinear distortion compensation portion 44.

In this way, by switching the nonlinear compensation of the transmitting terminal device 30 and the receiving terminal device 40 depending on the positional relationship of the distortion compensation section of the optical repeater 200, effective nonlinear compensation is possible. Since the distortion compensation by the optical repeater 200 cannot completely compensate for the nonlinear distortion occurring in the transmission line, some nonlinear distortion remains. For signals with residual nonlinear distortion, the effect of nonlinear distortion compensation by the digital signals of the transmitting terminal device 30 and the receiving terminal device 40 is not sufficient. By switching the nonlinear compensation of the transmitting terminal device 30 and the receiving terminal device 40 according to the positional relationship of the distortion compensation section of the optical repeater 200 as shown in this example embodiment, nonlinear distortion compensation of the transmitting terminal device 30 and the receiving terminal device 40 can be performed on a signal that does not have residual nonlinear distortion of phase conjugation, and the effect of nonlinear distortion compensation can be fully exerted. This makes it possible to maintain a sufficient effect of nonlinear distortion compensation regardless of the position of the repeater.

FIG. 13 illustrates a configuration example of the optical repeater 200 in an optical network system according to an example embodiment of the present disclosure.

As shown in FIG. 13, the optical repeater 200 according to an example embodiment of the present disclosure is equipped with an optical transmitter/receiver 201 and a node control portion 202. Although the illustration is omitted in FIG. 13, in order to perform transmission and reception of multiple optical channels, the optical repeater 200 includes the optical switch portion 300 and the transmission/reception portion 310, as in the basic example in FIG. 2, and includes a plurality of the optical transmitters/receivers 201 in the transmission/reception portion 310. In other words, the node control portion 202 controls the optical switch portion 300 and the transmission/reception portion 310 (the multiple optical transmitters/receivers 201 (equivalent to the optical transmitter/receiver 311 in FIG. 3)).

Each optical transmitter/receiver 201 is provided with the coherent reception front-end portion 210, the coherent transmission front-end portion 220, a digital signal processing portion 230, a reception light source 240, a transmission light source 250, an analog to digital converter (ADC) 260, and a digital to analog converter (DAC) 270.

The reception light source 240 generates local oscillator light r1 of the wavelength (frequency) set by the node control portion 202 and outputs the generated local oscillator light r1 to the coherent reception front-end portion 210. The transmission light source 250 generates the transmission light r2 of the wavelength (frequency) set by node control portion 202 and outputs the generated transmission light r2 to the coherent transmission front-end portion 220.

The frequency (wavelength) of the local oscillator light r1 is the frequency (carrier frequency) of the input optical signal SO1 that is received, and the frequency of the transmission light r2 is the frequency of the output optical signal SO2 that is transmitted. The carrier frequencies of the local light r1 and the transmission light r2 are determined based on carrier frequency information acquired by the node control portion 202 from the network management portion 110.

The coherent reception front-end portion 210 and the coherent transmission front-end portion 220 have the same configuration as in FIG. 3. The coherent reception front-end portion 210 is an optical/electrical converter that converts optical signals to electrical signals and is a coherent detection portion that performs coherent detection. The coherent reception front-end portion 210 performs coherent detection of the input optical signal SO1 (received optical signal) that is input based on the local oscillator light r1, and outputs the generated analog signal SA1 (first analog electrical signal).

The ADC 260 performs analog/digital conversion of the analog signal SA1 generated by the coherent reception front-end portion 210 and outputs the converted digital signal SD1 (first digital electrical signal).

The DAC 270 performs digital/analog conversion of the digital signal SD2 (second digital electrical signal) processed by the digital signal processing portion 230 and outputs the converted analog signal SA2 (second analog electrical signal).

The coherent transmission front-end portion 220 is an electrical/optical converter that converts electrical signals to optical signals and a coherent modulation portion that performs coherent modulation. The coherent transmission front-end portion 220 coherently modulates the analog signal SA2, which has been DA-converted by the DAC 270, based on the transmission light r2, and outputs the generated output optical signal SO2 (transmitted optical signal).

For example, the input optical signal SO1 and the output optical signal SO2 are phase modulated and polarization multiplexed optical signals. The analog signals SA1 and SA2 and digital signals SD1 and SD2 are four-lane (4-channel) signals that include the IX signal of the I component (in-phase component) of X polarization, the QX signal of the Q component (quadrature component) of X polarization, the IY signal of the I component of Y polarization, and the QY signal of the Q component of Y polarization.

The digital signal processing portion 230 performs digital signal processing on the digital signal SD1 converted by the ADC 260 and outputs the digital signal SD2 after digital signal processing. The digital signal processing portion 230 is a digital circuit that performs the prescribed digital signal processing to compensate for signal quality. The digital signal processing portion 230 performs digital signal processing on all or some of the four-lane IX, QX, IY, and QY signals (X or Y polarization), respectively.

The digital signal processing portion 230 performs specific signal processing without performing processing that involves significant delays, such as code error correction (data regeneration). This allows the required signal quality to be compensated while minimizing signal delay. In the present example embodiment, the digital signal processing portion 230 has a chromatic dispersion compensation portion 231 (equivalent to the chromatic dispersion compensation portion 23 in FIG. 6) that performs chromatic dispersion processing and a phase conjugation processing portion 232 (equivalent to the phase conjugation portion 22 in FIG. 6) that performs phase conjugation processing.

The chromatic dispersion compensation through digital signal processing can be realized by convolution of the impulse response of the inverse transfer function of an optical transmission line with the received signal. Thus, for example, the chromatic dispersion compensation portion 231 may be configured with a transversal filter (FIR filter). Since the characteristics of optical transmission lines can be modeled by an FIR filter, chromatic dispersion can be compensated by an FIR filter with inverse characteristics. The FIR filter performs TDE (Time Domain Equalizing), which equalizes the received signal in the time-delay domain, while FDE (Frequency Domain Equalization), which equalizes the received signal in the frequency domain, may achieve the same characteristics. By configuring the chromatic dispersion compensation portion with FDE, the circuit scale can be reduced compared to that of an FIR filter.

In addition to transmission line chromatic dispersion compensation, the chromatic dispersion compensation portion 231 may also compensate for bandwidth degradation caused by characteristic degradation and characteristic variation of analog electrical circuits in each of the four lanes of IX, QX, IY, and QY signals, amplitude variation in the four lanes, and skew and cross-talk in the four lanes.

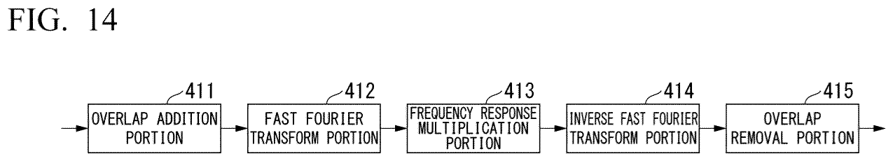

FIG. 14 is a configuration example in a case where the chromatic dispersion compensation portion 231 is configured by FDE processing. The chromatic dispersion compensation portion 231 in FIG. 14 is an example of an overlap FDE configuration and is provided with an overlap addition portion 411, a fast Fourier transform portion 412, a frequency response multiplication portion 413, an inverse fast Fourier transform portion 414, and an overlap removal portion 415.

The node control portion 202 sets the chromatic dispersion compensation amount notified by the control device 100 to the chromatic dispersion compensation portion 231 in the digital signal processing portion 230. In a case where the chromatic dispersion compensation portion 231 is configured with an FDE as shown in FIG. 14, the node control portion 202 sets the coefficient of the frequency response multiplication portion 413 in FIG. 14 according to the chromatic dispersion compensation amount notified by the control device 100 and the carrier frequency and signal bandwidth of each channel.

The overlap addition portion 411 causes a portion of the front and rear signals to overlap the input signal (digital signal). The fast Fourier transform portion 412 then performs a fast Fourier transform (FFT) of the overlapped signal to convert the signal into a frequency domain signal.

The frequency response multiplication portion 413 multiplies and equalizes the frequency response of the chromatic dispersion of the transmission line according to the chromatic dispersion compensation amount notified by the control device 100 and the carrier frequency and signal band of each channel.

The inverse fast Fourier transform portion 414 then performs the inverse fast Fourier transform (IFFT) to convert the signal into a time-domain signal. The overlap removal portion 415 removes the overlapping portion from the restored signal in the time domain and outputs it. In a case where using FDE, the chromatic dispersion compensation amount can be adjusted by changing the inverse transfer function. The overlap addition portion 411 and overlap removal portion 415 may be omitted.

Phase conjugation processing by digital signal processing finds the complex conjugate of the input digital signal. That is, the sign of the imaginary component Q in the Ix, Qx, Ty, and Qy signals is inverted as in the following Expression (1).

$$\begin{matrix}{I}_{X} = Re [ {I}_{X} - {jQ}_{x} ) {e}^{j ∅ 1} ] \\ {Q}_{X} = Im [ {I}_{X} - {jQ}_{x} ) {e}^{j ∅ 1} ] \\ {I}_{Y} = Re [ {I}_{Y} - {jQ}_{Y} ) {e}^{j ∅ 2} ] \\ {Q}_{Y} = Im [ {I}_{Y} - {jQ}_{Y} ) {e}^{j ∅ 2} ]\end{matrix} \} \qquad ( 1 )$$

The node control portion 202 receives control information from the control device 100 and controls each part of the optical repeater 200 based on the received control information. The node control portion 202 is an acquisition portion that acquires the optimal chromatic dispersion compensation amount according to each channel's frequency band from the chromatic dispersion compensation amount calculation portion 130, phase conjugation processing information from the phase conjugation determination portion 140, and reception wavelength information and transmission wavelength information from the network management portion 110. The node control portion 202 sets the frequency (wavelength) of the local oscillator light r1 to the reception light source 240 based on the acquired reception wavelength information and sets the frequency of the transmission light r2 to the transmission light source 250 based on the acquired transmission wavelength information. The node control portion 202 sets the phase conjugation processing operation to the phase conjugation processing portion 232 based on control information including instructions to perform phase conjugation processing acquired from the control device 100. The node control portion 202 sets the chromatic dispersion compensation amount to the chromatic dispersion compensation portion 231 based on the optimal chromatic dispersion compensation amount that was acquired.

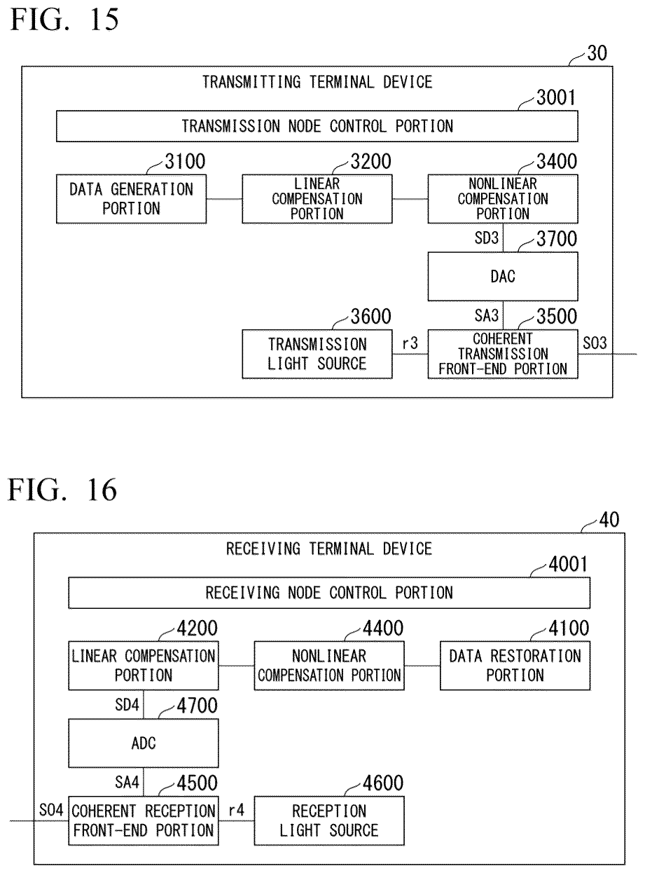

FIG. 15 illustrates a configuration example of the transmitting terminal device 30 in the optical network system 51 according to an example embodiment of the present disclosure.

Although not shown in FIG. 15, the transmitting terminal device 30 is provided with a multiplexer 302 as shown in FIG. 2 in order to transmit a plurality of optical channels. The transmitting terminal device 30 is also provided with a plurality of optical transmitters 311 for transmitting optical signals of each wavelength.

As shown in FIG. 15, the transmitting terminal device 30 according to one example embodiment of the present disclosure is provided with a transmission node control portion 3001, a data generation portion 3100, a linear compensation portion 3200, a nonlinear compensation portion 3400, a DAC 3700, a coherent transmission front-end portion 3500, and a transmission light source 3600.

The transmission node control portion 3001 acquires the wavelength of the transmission signal and nonlinear distortion compensation information from the control device 100. The transmission light source 3600 generates a local oscillator light r3 having a wavelength (frequency) set by the transmission node control portion 3001, and outputs the generated local oscillator light r3 to the coherent transmission front-end portion 3500. The frequency of the transmitted light r3 is the frequency of the output optical signal S03 to be transmitted.

As part of digital signal processing, the data generation portion 3100 performs error coding and bit symbol mapping to generate a transmission signal. The linear compensation portion 3200 performs pulse shaping, chromatic dispersion pre-equalization, front-end characteristic pre-equalization, and the like. The nonlinear compensation portion 3400 performs nonlinear compensation such as the digital back-propagation method shown in FIG. 9.

The DAC 3700 performs digital-to-analog conversion on the digital signal SD3 that has been signal-processed by the nonlinear compensation portion 3400, and outputs the converted analog signal SA3. The digital signal processing generates SD3, which is output to the DAC 3700.

The coherent transmission front-end portion 3500 is an electrical/optical converter that converts electrical signals to optical signals and a coherent modulation portion that performs coherent modulation. The coherent transmission front-end portion 3500 coherently modulates the analog signal SA3 that has been DA converted by the DAC 3700 based on a transmission light r3, and outputs the generated output optical signal S03 (transmission optical signal).

FIG. 16 illustrates a configuration example of the receiving terminal device 40 in the optical network system 51 according to an example embodiment of the present disclosure.

Although not shown in FIG. 16, the receiving terminal device 40 is provided with the demultiplexer 301 as shown in FIG. 2 in order to receive a plurality of optical channels. The receiving terminal device 40 includes a plurality of optical receivers 311 for receiving optical signals of each wavelength.

As shown in FIG. 16, the receiving terminal device 40 according to one example embodiment of the present disclosure is provided with a receiving node control portion 4001, a data restoration portion 4100, a linear compensation portion 4200, a nonlinear compensation portion 4400, an ADC 4700, a coherent reception front-end portion 4500, and a reception light source 4600.

The receiving node control portion 4001 acquires the wavelength of the reception signal and nonlinear distortion compensation information from the control device 100. The reception light source 4600 generates a local oscillator light r4 having a wavelength (frequency) set by the reception node control portion 4001, and outputs the generated local oscillator light r4 to the coherent reception front-end portion 4500.

The coherent reception front-end portion 4500 is an optical/electrical converter that converts optical signals to electrical signals and is a coherent detection portion that performs coherent detection. The coherent reception front-end portion 4500 performs coherent detection of the input optical signal SO4 (received optical signal) based on the local oscillator light r4, and outputs the generated analog signal SA4.

The ADC 4700 performs analog/digital conversion of the analog signal SA4 generated by the coherent receiver front-end portion 4500, and outputs the converted digital signal SD4.

For SD3, the linear compensation portion 4200 performs digital signal processing such as pulse shaping, chromatic dispersion compensation, and front-end characteristic pre-equalization, while the nonlinear compensation portion 4400 performs nonlinear compensation using the digital back-propagation method as shown in FIG. 9. The data restoration portion 4100 restores the data by performing processes such as polarization separation, frequency offset compensation, phase recovery, and error correction.

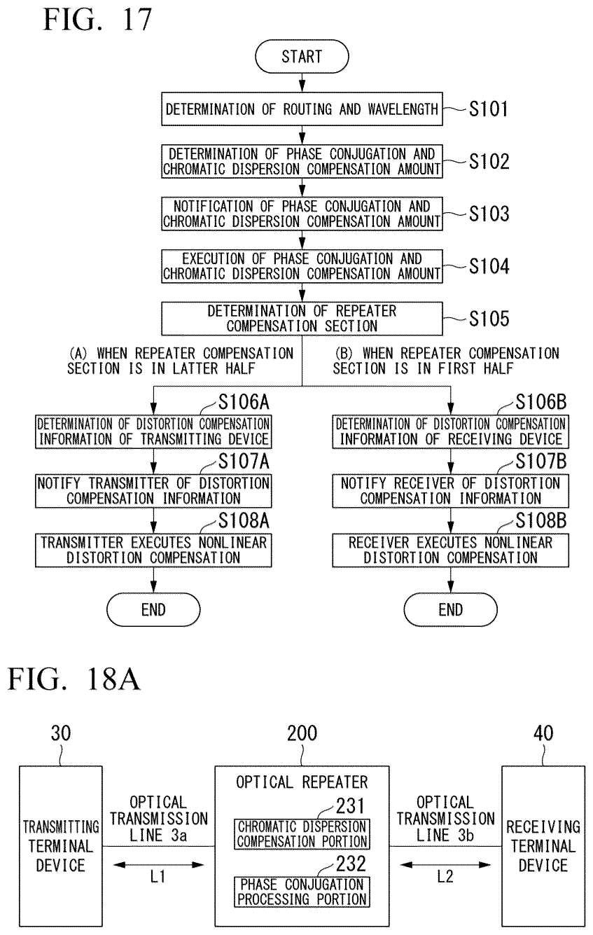

FIG. 17 shows an example of the operation of the optical network system according to the example embodiment of the present disclosure. As shown in FIG. 17, first, the network management portion 110 of the control device 100 determines the position of the optical repeater 200, transmission line information of the optical transmission lines before and after the optical repeater 200, and the wavelength to be used by the optical repeater 200 (S101). The network control portion 120 of the control device 100 determines the path route in the optical network 51 and identifies the optical transmission line and the position of the optical repeater 200 on the path route. The network control portion 120 outputs the reception wavelength information and transmission wavelength information of the optical repeater 200 to the chromatic dispersion compensation amount calculation portion 130 and the phase conjugation determination portion 140 according to the determined wavelength. The network control portion 120 also outputs the transmission line information (distance) of the optical transmission lines upstream and downstream of the optical repeater 200 to the chromatic dispersion compensation amount calculation portion 130 and the phase conjugation determination portion 140. In a case where a plurality of optical repeaters 200 are included in the path that constitutes the optical network 51, the following process is performed for each optical repeater 200. The network control portion 120 outputs the determined reception wavelength information of the receiving terminal device 40 to the receiving terminal device 40.

Next, the chromatic dispersion compensation amount calculation portion 130 of the control device 100 calculates the chromatic dispersion characteristics in the optical transmission lines upstream and downstream of the optical repeater 200, and determines the phase conjugation and the amount of chromatic dispersion compensation (S102). A specific example of a method for determining the phase conjugation and the amount of chromatic dispersion compensation will be described later. The chromatic dispersion compensation amount calculation portion 130 calculates the chromatic dispersion characteristics in the preceding and following optical transmission lines of each optical repeater 200, based on the reception wavelength information and transmission wavelength information acquired from the network control portion 120 and the transmission line information (distance) of the front-stage and rear-stage optical transmission line of the optical repeater 200. If the transmission information includes the structure, type, and transmission characteristics of the optical fiber, the chromatic dispersion characteristic may be determined based on this information. For example, the chromatic dispersion characteristic is the slope of the accumulated chromatic dispersion amount with respect to the distance of the optical transmission line (chromatic dispersion amount as a function of distance (FIG. 4)). Since the slope of the chromatic dispersion amount varies with wavelength, a table relating the wavelength (or wavelength band) to the slope of the chromatic dispersion may be stored in advance. The chromatic dispersion compensation amount calculation portion 130 may refer to this table to determine the chromatic dispersion characteristic corresponding to the wavelength. In other words, the chromatic dispersion characteristic is a value that is determined according to the structure and type of the optical fibers that make up the optical network 51, the transmission characteristics, and the frequency of the light used for communication. The chromatic dispersion characteristic may be calculated by inputting the value determined according to the structure and type of optical fibers constituting the optical network, the transmission characteristics, and the frequency of light used for communication into a predetermined calculation formula.

The chromatic dispersion compensation amount calculation portion 130 determines the optimal chromatic dispersion compensation amount in the optical repeater 200 based on the chromatic dispersion characteristics of the front-stage and rear-stage optical transmission lines of the optical repeater 200 and the transmission line information of the front-stage and rear-stage optical transmission lines. The chromatic dispersion compensation amount calculation portion 130 calculates the chromatic dispersion amount accumulated in the optical transmission line in the front stage (reception side) and the chromatic dispersion amount accumulated in the optical transmission line in the rear stage (transmission side), and determines the optimum chromatic dispersion amount based on the front-stage and rear-stage chromatic dispersion amounts. In particular, the chromatic dispersion compensation amount calculation portion 130 determines the optimal chromatic dispersion amount based on the chromatic dispersion amount accumulated between the transmitting terminal device 30 and the optical repeater 200 and the chromatic dispersion amount accumulated between the optical repeater 200 and the receiving terminal device 40. For example, the chromatic dispersion compensation amount calculation portion 130 calculates the chromatic dispersion amount accumulated in the front-stage optical transmission line based on the chromatic dispersion characteristic and transmission line information (distance) of the front-stage optical transmission line of the optical repeater 200 and calculates the chromatic dispersion amount accumulated in the rear-stage optical transmission line based on the chromatic dispersion characteristic and transmission line information of the rear-stage optical transmission line of the optical repeater 200. Note that in this example, the chromatic dispersion compensation amount calculation portion 130 determines the chromatic dispersion compensation amount based on the chromatic dispersion characteristics and transmission line information, since the chromatic dispersion characteristic corresponds to wavelength information, the chromatic dispersion compensation amount may be determined based on wavelength information and transmission line information. In other words, the chromatic dispersion compensation amount calculation portion 130 may determine the chromatic dispersion compensation amount in the plurality of optical repeaters 200 comprising the path based on wavelength information and transmission line information in the path. The phase conjugation determination portion 140 determines the optimal phase conjugate processing in the optical repeater 200 of the optical network 51.

Next, the control device 100 notifies the optical repeater 200 of the routing information, reception wavelength information and transmission wavelength information determined in S101, the optimal phase conjugation processing information determined in S102, and the optimal chromatic dispersion compensation amount (S103).

Next, the optical repeater 200 performs signal transmission and reception, phase conjugation processing, and chromatic dispersion compensation based on the information notified in S103 (S104). The node control portion 202 of the optical repeater 200 sets the wavelength of the wavelength information, the phase conjugation processing information, and the optimal chromatic dispersion compensation amount notified by the control device 100. The node control portion 202 sets the wavelength of the acquired reception wavelength information to the reception light source 240, and sets the wavelength of the acquired transmission wavelength information to the transmission light source 250. The node control portion 202 sets the acquired phase conjugation processing information to the phase conjugation processing portion 232, and the acquired optimal chromatic dispersion compensation amount to the chromatic dispersion compensation portion 231. The reception light source 240 generates a local oscillator light r1 of the set wavelength (frequency) and the transmission light source 250 generates a transmission light r2 of the set wavelength, thereby performing wavelength conversion in the optical transmitter/receiver 201. The phase conjugation processing portion 232 performs the phase conjugation processing by phase conjugation, and the chromatic dispersion compensation portion 231 performs the chromatic dispersion compensation processing based on the set compensation amount by performing digital signal processing on the signal after the phase conjugation processing.

Next, the distortion compensation section determination portion 150 of the control device 100 determines the distortion compensation section, which is the transmission line for which the optical repeater 200 performs nonlinear distortion compensation (S105). The distortion compensation section determination portion 150 determines the distortion compensation section, which is the transmission line for which the optical repeater 200 will perform nonlinear distortion compensation, based on the transmission line information determined by the network management portion 110, the path route, the position information of the optical repeater 200, and the information on phase conjugation and chromatic dispersion compensation amount determined in S102. For example, the distortion compensation section determination portion 150 determines the distortion compensation section of the optical repeater 200 as described with reference to FIG. 12A and FIG. 12B.

Next, the distortion compensation control portion 160 of the control device 100 determines nonlinear distortion compensation information related to distortion compensation in the transmitting terminal device 30. Alternatively, the distortion compensation control portion 160 of the control device 100 determines nonlinear distortion compensation information related to distortion compensation in the receiving terminal device 40. Specifically, if the distortion compensation section, which is the transmission line for which the optical repeater 200 perform nonlinear distortion compensation as determined in Step S105, is located downstream of the center position of the distance from the transmitting terminal device 30 to the receiving terminal device 40 of the optical network 51, the distortion compensation control portion 160 determines the nonlinear distortion compensation information that the transmitting terminal device 30 will use in the distortion compensation process, assuming that the transmitting terminal device 30 will perform distortion compensation on the transmission line outside the distortion compensation section (S106A). If the distortion compensation section, which is the transmission line for which the optical repeater 200 perform nonlinear distortion compensation as determined in Step S105, is located upstream of the center position of the distance from the transmitting terminal device 30 to the receiving terminal device 40 of the optical network 51, the distortion compensation control portion 160 determines the nonlinear distortion compensation information that the receiving terminal device 40 will use in the distortion compensation process, assuming that the receiving terminal device 40 will perform distortion compensation on the transmission line outside the distortion compensation section (S106B).

In determining the above-mentioned distortion compensation section, the distortion compensation section determination portion 150 may obtain the transmission line information, the path route, and the position information of the optical repeater 200 determined by the network management portion 110, and compare the number of transmission lines between the transmitting terminal device 30 and the optical repeater 200. Then, in a case where the number of transmission lines between the optical repeater 200 and the transmitting terminal device 30 matches the number of transmission lines between the optical repeater 200 and the receiving terminal device 40, the distortion compensation section determination portion 150 may determine all of the transmission lines from the transmitting terminal device 30 to the receiving terminal device 40 serve as a distortion compensation section of the optical repeater 200. In addition, if the number of transmission lines between the optical repeater 200 and the transmitting terminal device 30 does not match the number of transmission lines between the optical repeater 200 and the receiving terminal device 40, the distortion compensation section determination portion 150 may specify the smaller number among the transmission lines that reach the transmitting terminal device 30 and the receiving terminal device 40, with the optical repeater 200 at the center, in the upstream and downstream stages of the optical repeater 200. For example, as shown in FIG. 12A, the distortion compensation section determination portion 150 compares the number of transmission lines “4” that reach the transmitting terminal device 30, centered on the optical repeater 200, with the number of transmission lines “2” that reach the receiving terminal device 40, and specifies the transmission lines with the smaller number “2” in the upstream and downstream stages of the optical repeater 200 (transmission lines 3C, 3D, 3E, and 3F). The distortion compensation section determination portion 150 then determines that the identified transmission lines (transmission lines 3C, 3D, 3E, and 3F) upstream and downstream of the optical repeater 200 as the distortion compensation section of the optical repeater 200. The distortion compensation section determination portion 150 determines that the unspecified transmission lines 3A and 3B to be the distortion compensation section of the transmitting terminal device 30 that is close to these transmission lines.

The distortion compensation control portion 160 may determine the nonlinear distortion compensation information based on transmission line information such as chromatic dispersion characteristics, nonlinear characteristics, and signal propagation loss characteristics managed by the network management portion 110. In a case where the transmitting terminal device 30 or the receiving end device 40 performs distortion compensation processing using the digital back-propagation method, for example, parameters related to the number of steps and phase rotation may be determined as the nonlinear distortion compensation information.

Next, the transmitting terminal device 30 notifies the receiving terminal device 40 of the nonlinear distortion compensation information determined in S106A (S107A). Alternatively, the receiving terminal device 40 notifies the transmitting terminal device 30 of the nonlinear distortion compensation information determined in S106B (S107B).

Next, the transmitting terminal device 30 or the receiving terminal device 40 performs nonlinear distortion compensation. Specifically, in a case where the distortion compensation section, which is the transmission line for which the optical repeater 200 determined in S105 is to perform nonlinear distortion compensation, is located downstream of the center position of the distance from the transmitting terminal device 30 to the receiving terminal device 40 of the optical network 51, the transmission node control portion 3001 of the transmitting terminal device 30 sets the nonlinear distortion compensation information of the transmitting terminal device 30 in the nonlinear compensation portion 3400. The nonlinear compensation portion 3400 of the transmitting terminal device 30 performs nonlinear distortion compensation based on the set nonlinear distortion compensation information (S108A). In a case where the distortion compensation section, which is the transmission line for which the optical repeater 200 determined in S105 is to perform nonlinear distortion compensation, is located upstream of the center position of the distance from the transmitting terminal device 30 to the receiving terminal device 40 of the optical network 51, the receiving node control portion 4001 of the receiving terminal device 40 sets the nonlinear distortion compensation information of the receiving terminal device 40 in the nonlinear compensation portion 4400. The nonlinear compensation portion 4400 of the receiving terminal device 40 performs nonlinear distortion compensation based on the set nonlinear distortion compensation information (S108B).

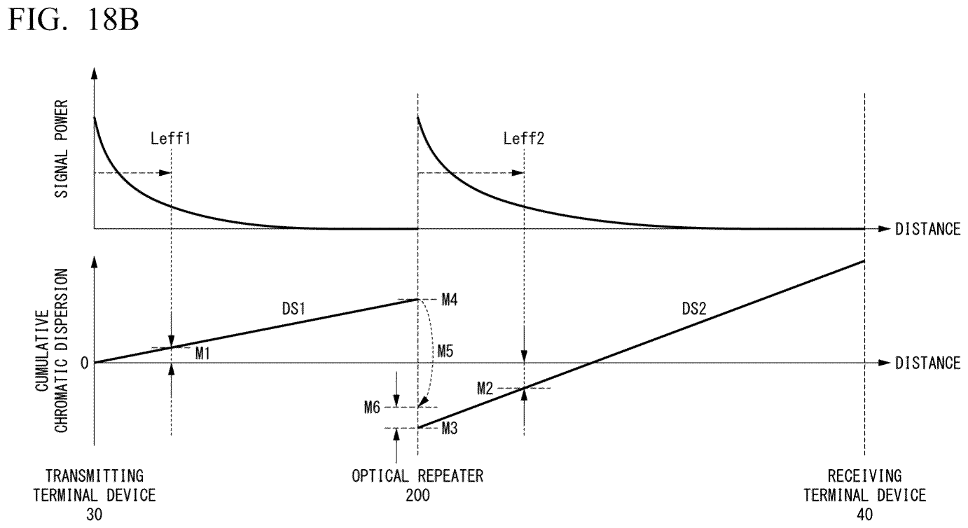

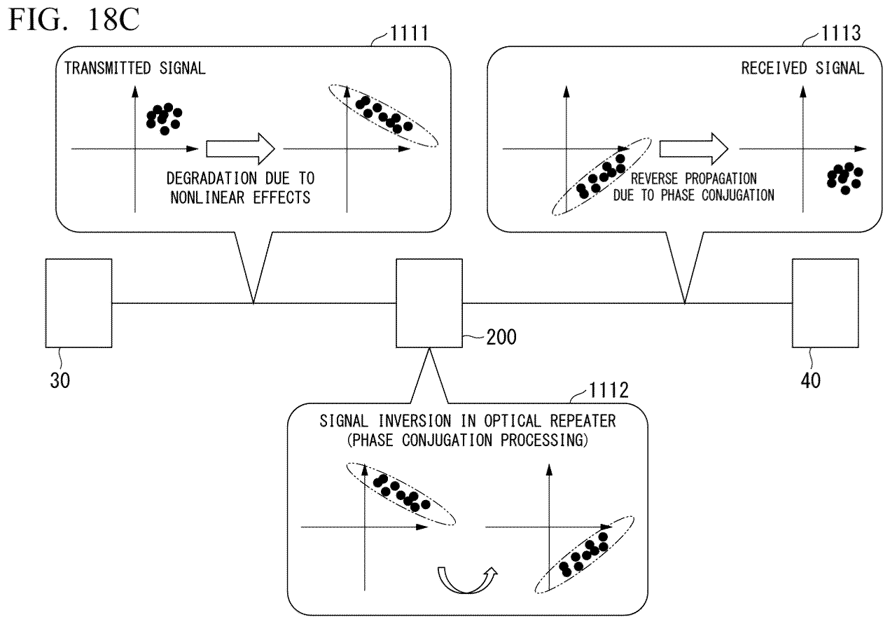

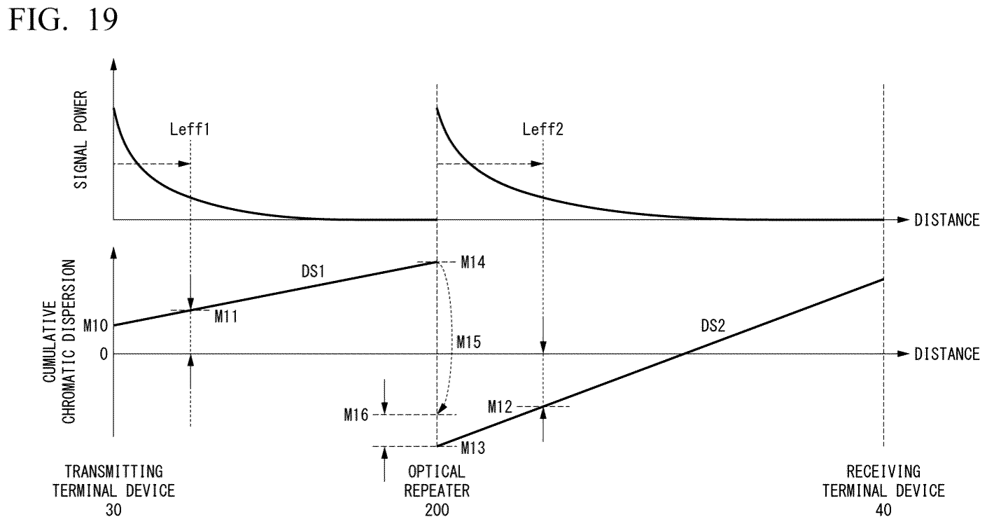

FIG. 18A and FIG. 18B show specific examples of phase conjugation processing and chromatic dispersion compensation processing in the optical repeater by the control method of the one example embodiment of the present disclosure. In this specific example, the effect of nonlinear distortion compensation by phase conjugation and chromatic dispersion compensation performed by the optical repeater 200 can be maximized for the distortion compensation section, which is the transmission line for which the optical repeater 200 performs nonlinear distortion compensation, as determined by the distortion compensation section determination portion 150 of the control device 100.

Here, as an example, an optical network is shown in which the distortion compensation section, which is the transmission line for which the optical repeater 200 performs nonlinear distortion compensation, is made up of two transmission line sections, the first half of which indicates the transmission line section from the transmitting terminal device 30 to the optical repeater 200, and the second half of which indicates the transmission line section from the optical repeater 200 to the receiving terminal device 40. However, the same is true in a case where the distortion compensation section, which is the transmission line for which the optical repeater 200 performs nonlinear distortion compensation, is composed of a total of 2N transmission line sections, including a first half showing N transmission line sections from the transmitting terminal device 30 to the optical repeater 200, and a second half showing N transmission line sections from the optical repeater 200 to the receiving terminal device 40, where N is an integer greater than or equal to 2. Also, in this example, the end points of the distortion compensation section are the transmitting terminal device 30 and the receiving terminal device 40, but the end points may be considered to be amplifiers in the transmission line.

In the present example embodiment, phase conjugation processing is performed in the optical repeater 200 on the nonlinear distortion accumulated in the front-stage optical transmission line in the optical signal received by the optical repeater 200. This allows the nonlinear distortion in the transmission of optical signals transmitted from the optical repeater 200 in the rear-stage optical transmission line to be cancelled out at the receiving terminal device 40. To achieve this effect, the optical repeater 200 in the present example embodiment determines the optimal chromatic dispersion compensation amount such that the nonlinear distortion cancellation effect is maximized. The optimal chromatic dispersion compensation amount in this example is the compensation amount calculated based on the chromatic dispersion amount in the front-stage transmission line section and the rear-stage transmission line section for the optical repeater 200. In this example, the digital signal processing portion 230 of the optical repeater 200 determines the optimal chromatic dispersion compensation amount in a case where performing chromatic dispersion compensation processing after the phase conjugation processing. Even in a case where the digital signal processing portion 230 performs phase conjugation processing after the chromatic dispersion compensation processing, it may similarly determine the optimal chromatic dispersion compensation amount based on the chromatic dispersion amount in the front-stage and rear-stage transmission lines. In this example, the phase conjugation processing is performed first in the digital signal processing portion 230, followed by the chromatic dispersion compensation processing.

As shown in FIG. 18A, in this example, one optical repeater 200 is located on the path between the transmitting terminal device 30 and the receiving terminal device 40. The transmitting terminal device 30 and the optical repeater 200 are connected via the optical transmission line 3a (first optical transmission line), and the optical repeater 200 and the receiving terminal device 40 are connected via the optical transmission line 3b (second optical transmission line). For example, the distance L1 of optical transmission line 3a and the distance L2 of optical transmission line 3b are different; with the distance L2 of the optical transmission line 3b being longer than the distance L1 of the optical transmission line 3a, but they may also be the same distance. Optical signals of wavelength λ1 are transmitted in the optical transmission line 3a, and optical signals of wavelength λ2 are transmitted in the optical transmission line 3b. For example, wavelengths λ1 and λ2 may both be in the C-band wavelength band, or they may be different, such as C-band and L-band wavelength bands, respectively, or they may both be in the L-band wavelength band. The optical repeater 200 converts the optical signal of wavelength λ1 that is received into an optical signal of wavelength 22, and transmits the converted optical signal of wavelength λ2.

As shown in FIG. 18B, since the wavelength of the optical signal is λ1 in the front-stage optical transmission line 3a, the chromatic dispersion compensation amount calculation portion 130 of the control device 100 determines the slope DS1 of the chromatic dispersion amount in the optical transmission line 3a according to the wavelength λ1. The slope DS1 of the chromatic dispersion amount in the optical transmission line 3a may be read from a database or other storage means. The chromatic dispersion compensation amount calculation portion 130 of the control device 100 uses the slope DS1 of the chromatic dispersion amount and the effective nonlinear distance Leff1 in the optical transmission line 3a to obtain the accumulated chromatic dispersion amount M1 (=DS1×Leff1) at the effective nonlinear distance Leff1 in the front-stage optical transmission line 3a. Since nonlinear effects are effects that depend on the optical signal intensity, and the optical intensity in a transmission line decreases according to an exponential shape characterized by a propagation loss constant, it is sufficient to consider nonlinear effects only in regions of high optical intensity. The effective nonlinear distance Leff is defined as the distance at which nonlinear effects are considered, and Leff is given by the following Expression (2) using the length L and the propagation loss constant α in the optical fiber.

$$Leff = \frac{1 - {e}^{- α L}}{2 α} \qquad ( 2 )$$

Since the wavelength of the optical signal in the rear-stage optical transmission line 3b is λ2, the chromatic dispersion compensation amount calculation portion 130 of the control device 100 determines the slope DS2 of the chromatic dispersion amount in the optical transmission line 3b according to the wavelength λ2. The slope DS2 of the chromatic dispersion amount in optical transmission line 3b may be read from a database or other storage means. The chromatic dispersion compensation amount calculation portion 130 of the control device 100 calculates the accumulated chromatic dispersion amount M2 at the effective nonlinear distance Leff2 in the rear-stage optical transmission line 3b as M2=−M1, on the condition of having a different sign from the accumulated chromatic dispersion amount M1 at the effective nonlinear distance Leff1 in the front-stage optical transmission line 3a. The chromatic dispersion compensation amount calculation portion 130 then finds the accumulated chromatic dispersion amount M3 in the transmission signal of the optical repeater. M3 can be calculated by

$$M 3 = M 2 + DS 2 \times Leff 2 = DS 1 \times Leff 1 + DS 2 \times Leff 2 .$$

The chromatic dispersion compensation amount calculation portion 130 of the control device 100 then determines the cumulative chromatic dispersion compensation amount M5 for the optical repeater 200 to compensate chromatic dispersion using phase conjugation by M5=M4×2.

The chromatic dispersion compensation amount calculation portion 130 of the control device 100 finds the difference M6 between the accumulated chromatic dispersion amount M3 and the cumulative chromatic dispersion compensation amount M5, and transmits the difference M6 to the optical repeater 200 as the optimal chromatic dispersion compensation amount. The control device 100 also transmits control information including instructions to implement the phase conjugation process to the optical repeater 200. As a result, the node control portion 202 of the optical repeater 200 instructs the phase conjugation processing portion 232 to perform the phase conjugation processing operation based on the control information including the acquired instruction to perform the phase conjugation processing, as explained using FIG. 13. The phase conjugation processing portion 232 performs the phase conjugation processing operations. The node control portion 202 of the optical repeater 200 sets the chromatic dispersion compensation amount M6 notified by the control device 100 to the chromatic dispersion compensation portion 231 in the digital signal processing portion 230, as described using FIG. 13. In other words, in a case where the chromatic dispersion compensation portion 231 is configured with an FDE as shown in FIG. 13, the node control portion 202 sets the multiplication factor of the frequency response multiplication portion 413 in FIG. 14 according to the chromatic dispersion compensation amount M6 notified from the control device 100. As a result, the optical repeater 200, for the rear-stage optical transmission line 3b, calculates the cumulative chromatic dispersion M3 (M3=M4-M5-M6) after calculation of the cumulative chromatic dispersion compensation amount M5 using the phase conjugation processing of the phase conjugation processing portion 232 and the chromatic dispersion compensation using the chromatic dispersion compensation amount M6 of the chromatic dispersion compensation portion 231, and outputs an optical signal that is the cumulative chromatic dispersion M3 (FIG. 14B). This suppresses nonlinear effects in the receiving terminal device 40.

The optical repeater 200 can calculate the accumulated chromatic dispersion amount M3 without phase conjugation by M3=M2+DS2×Leff2=DS1×Leff1+DS2×Leff2. Accordingly, the chromatic dispersion compensation portion 231 of the optical repeater 200 may calculate the relevant accumulated chromatic dispersion amount M3 and output an optical signal that is the relevant cumulative chromatic dispersion amount M3 without phase conjugation (FIG. 14B).

In the explanation of FIGS. 12A and 12B, for convenience of explanation, it is explained that the optical signal of wavelength λ1 is transmitted in the optical transmission line 3a and the optical signal of wavelength λ2 is transmitted in the optical transmission line 3b, but multi-channel optical signals of multiple wavelengths, (frequency bands) may be transmitted in the optical transmission line 3a, and multi-channel optical signals of multiple wavelengths k (frequency bands) may be transmitted in the optical transmission line 3b.

FIG. 18C is a diagram showing an overview of the phase conjugation process.

As shown in FIG. 18C, at a certain transmission line section in the optical network 51 (between network devices such as the transmitting terminal device 30 and the optical repeater 200 in FIG. 18C), nonlinear distortion of the transmitted signal occurs as signal degradation due to nonlinear effects (1111 in FIG. 18C). Phase conjugation processing (inversion of the optical signal) is performed at the optical repeater 200 (1112 in FIG. 18C). This enables the phase conjugation to be used to cancel out the nonlinear distortion in the transmission line section after the optical repeater 200 (between the optical repeater 200 and the receiving terminal device 40), thereby reducing signal degradation (nonlinear distortion) at the receiving terminal device 40 (1113 in FIG. 18C). In addition to this, optimal chromatic dispersion compensation for each channel's signal bandwidth in a case where the optical repeater 200 receives multi-channel signals can be used to maximize the cancellation effect of nonlinear distortion at the receiving terminal device 40.

The aforementioned processing in the control device 100 described above is an example aspect of processing that determines the chromatic dispersion compensation amount for compensation in the optical repeater 200 based on the wavelength information of the optical signal transmitted and received by the optical repeater 200 that is included in the optical network in the optical network path and the transmission line information of the optical transmission line connected to the optical repeater 200, and determines the phase conjugation processing in the optical repeater 200 based on the wavelength information and transmission line information.

Some of the processing in the control device 100 is an example aspect of processing that transmits to the optical repeater 200 an instruction to perform phase conjugation processing to calculate the complex conjugation of the optical signal concerned based on the accumulated chromatic dispersion amount M4 of the optical signal received by the optical repeater 200.

Some of the processing in the control device 100 is an example aspect of processing that calculates the first accumulated chromatic dispersion amount M1 at a first effective nonlinear distance (Leff1) with reference to the transmission-side network device in a first optical transmission line (front-stage path) between a transmission-side network device that transmits an optical signal received by the optical repeater 200 among the optical transmission lines to which the optical repeater 200 is connected.

Some processing in the control device 100 is an example aspect of processing that calculates a second accumulated chromatic dispersion amount (M2), having the opposite sign (multiplied by −1) to the first accumulated chromatic dispersion amount, in a second effective nonlinear distance (Leff2) based on the device itself of the optical signal in the second optical transmission line (rear-stage path) with the reception-side network device of the optical signal transmitted by the optical repeater 200, among the optical transmission lines to which the optical repeater 200 is connected.

Some of the processing in the control device 100 is an example aspect of processing that calculates the chromatic dispersion compensation amount (M6), which indicates the difference between the chromatic dispersion amount (M3) during transmission of an optical signal in the optical repeater 200 in a case where the accumulated chromatic dispersion amount of an optical signal becomes the second accumulated chromatic dispersion amount (M2) at the second effective nonlinear distance (Leff2), based on a statistical value (DS2) of a transition of the accumulated chromatic dispersion amount of an optical signal according to the distance in a second optical transmission line, and the chromatic dispersion amount (M5) resulting from complex conjugation.

The processing of the optical repeater 200 described above is an example aspect of processing that performs chromatic dispersion compensation processing on an electrical signal based on a received optical signal, based on the chromatic dispersion compensation amount (M6), and performs phase conjugation processing on an electrical signal based on a received optical signal, based on phase conjugation processing information acquired from the control device 100.

Some processing described above in the optical repeater 200 is an example aspect of processing that performs phase conjugation processing based on the accumulated chromatic dispersion amount of an optical signal received by the device itself and an instruction to perform phase conjugation processing in order to calculate the complex conjugation of the optical signal.

Some of the processing in the optical repeater 200 described above is an example aspect of processing to determine the chromatic dispersion amount (M3) of an optical signal transmitted to the reception-side network device, based on the chromatic dispersion amount (M5), which is the result of the complex conjugation after the phase conjugation processing, and the chromatic dispersion compensation amount (M6) acquired from the control device 100.

FIG. 19 shows another example of the chromatic dispersion compensation amount by the control method according to an example embodiment of the present disclosure. Unlike FIG. 18B, in this example, as shown in FIG. 19, the transmitting terminal device 30 transmits an optical signal with accumulated chromatic dispersion amount M10 to the optical transmission line 3a. In addition, if the transmitting terminal device 30 is considered to be an optical repeater 200 or a signal amplifier in the optical network 51, dispersion such as the accumulated chromatic dispersion amount M10 may occur in the optical signal transmitted by the transmitting terminal device 30.

As shown in FIG. 19, in an optical transmission line 3a upstream of the optical repeater 200, the wavelength of an optical signal is λ1, so the control device 100 determines the slope DS1 of the amount of chromatic dispersion in the optical transmission line 3a in accordance with the wavelength λ1. The control device 100 uses the effective nonlinear distance Leff1 to obtain the amount of accumulated chromatic dispersion M11 (=DS1×Leff1+M10) at the effective nonlinear distance Leff1 in the upstream optical transmission line 3a.

Since the wavelength of the optical signal in the rear-stage optical transmission line 3b is λ2, the control device 100 determines the slope DS2 of the chromatic dispersion amount in the optical transmission line 3b according to the wavelength λ2. The control device 100 determines the accumulated chromatic dispersion amount M13 (=DS1×Leff1+DS2×Leff2+M10) in the transmission signal of the optical repeater under the condition that the accumulated chromatic dispersion amount M12 at the effective nonlinear distance Leff2 in the downstream optical transmission line 3b has the opposite sign to the accumulated chromatic dispersion amount M11 at the effective nonlinear distance Leff1 in the upstream optical transmission line 3a. The control device 100 obtains a phase conjugate compensation amount M15 (=M14×2) that is compensated for by the phase conjugation in the optical repeater 200.

The control device 100 obtains the difference M16 between M13 and M15, and sets M6 in the optical repeater 200 as the optimal amount of chromatic dispersion compensation. The control device 100 sets the optical repeater 200 to perform phase conjugation processing.

As described above, in the present example embodiment, in the optical repeater 200 that performs wavelength conversion on a channel-by-channel basis, the analog signal output from the coherent receiving front-end portion 210 is converted to a digital signal by an ADC, subjected to digital signal processing, and then converted back to an analog signal by a DAC, and relayed back to the coherent transmission front-end portion 220. At this time, the digital signal processing portion 230 performs phase conjugation processing. At this time, the digital signal processing portion 230 compensates for chromatic dispersion distortion occurring in the optical fiber transmission line on the basis of the transmission line length of the network path (transmission line) and the signal band and carrier frequency of the signal channel. Furthermore, in the coherent transmission front-end portion 220, the carrier frequencies are set so that the order of the channels is reversed in the frequency domain.

Specifically, the control device 100 determines an optimal amount of chromatic dispersion compensation in the frequency band of each channel to be compensated for by the optical repeater so that the accumulated chromatic dispersion amount in the effective nonlinear distance in the upstream transmission line and the accumulated chromatic dispersion amount in the effective nonlinear distance in the downstream transmission line have opposite signs, and the optical repeater 200 performs phase conjugation and chromatic dispersion compensation based on the determined optimal amount of chromatic dispersion compensation, and the signal band and carrier frequency of the signal channel. This allows the nonlinear distortion accumulated in the front-stage optical transmission line at the receiving end of the optical repeater 200 to be offset by the optical transmission in the rear-stage optical transmission, maximizing the effect of suppressing the nonlinear distortion in the receiving terminal device 40. Furthermore, even if an unnecessary amount of dispersion is contained in the signal transmitted by the transmitting terminal device 30 as shown in FIG. 12, an appropriate amount of chromatic dispersion can be set in the optical repeater 200, and the nonlinear distortion can be compensated for. Furthermore, by setting the carrier frequency in the coherent transmission front-end portion 220 so that the order of each channel is reversed in the frequency domain, it is possible to reduce inter-channel nonlinear distortion.

### Example Embodiment 2

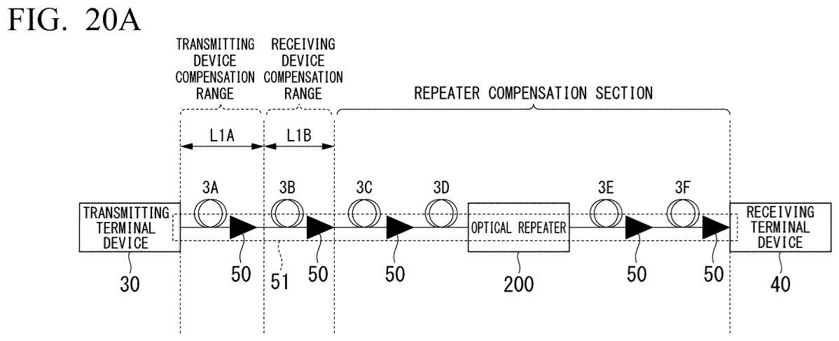

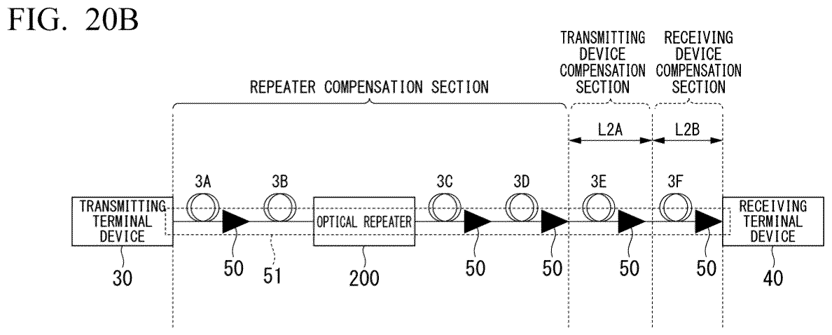

Next, Example Embodiment 2 shall be explained with reference to the drawings. In this example embodiment, the configuration and basic operation of the optical network system are similar to those in Example Embodiment 1. FIGS. 20A and 20B show the concept of a control method for the distortion compensation processing of the transmitting/receiving terminal device 30 controlled by the distortion compensation control portion 160 of the control device 100, based on information on the distortion compensation section of the optical repeater 200 determined by the distortion compensation section determination portion 150 of the control device 100 in this example embodiment. In the present example embodiment, an example will be described in which both the transmitting terminal device 30 and the receiving terminal device 40 perform nonlinear distortion compensation.

FIG. 20A is a first diagram showing the concept of the control method for the distortion compensation process of the transmitting/receiving terminal device 30 controlled by the distortion compensation control portion 160 of the control device 100. It is assumed that the optical transmission line includes six transmission line sections (3A, 3B, 3C, 3D, 3E, 3F), and that the optical network 51 is composed of five optical signal amplifiers 50 that compensate for the transmission loss in one transmission line section, one optical repeater 200, one transmitting terminal device 30, and one receiving terminal device 40. The optical repeater 200 is located in the rear half from the center between the transmitting terminal device 30 and the receiving terminal device 40.

For example, assume that an optical repeater 200 is located between transmission lines 3D and 3E as shown in FIG. 20A. As described with reference to FIG. 12A in the first example embodiment, the distortion compensation section determination portion 150 of the control device 100 determines the distortion compensation section of the optical repeater 200 to be 3C to 3F. The distortion compensation control portion 160 of the control device 100 takes into consideration noise originating from the front end in the transmitting terminal device 30, noise originating from the front end in the receiving terminal device 40, and noise added due to signal amplification or the like in the transmission lines 3A to 3F, and determines the distortion compensation section LlA of the transmitting terminal device 30 and the distortion compensation section LiB of the receiving terminal device 40 outside the distortion compensation section of the optical repeater 200 (transmission lines 3A, 3B) so as to maximize the effect of the nonlinear distortion compensation performed by the transmitting terminal device 30 and the receiving terminal device 40. Specifically, the distortion compensation control portion 160 of the control device 100 may store in advance a data table that associates the magnitude of noise (SNR, etc.) obtained in advance by simulation or transmission evaluation in a case where noise originating from the transmission line or noise originating from the transmitting/receiving front end is present with information on the optimal distortion compensation section to be compensated for by the transmitting terminal device 30 and the receiving end device 40 (transmitting/receiving device), and determine the distortion compensation sections L1A and L2B according to the data table.

The noise originating from the front end in the transmitting terminal device 30 and the noise originating from the front end in the receiving terminal device 40 may be evaluated in advance individually using a signal analyzer or the like provided in the transmitting terminal device 30, or may be estimated using an equalization algorithm (equalization processing using signal optimization in the digital signal processing). Note that noise originating from the front end refers to noise caused by the driver amplifier's non-linearity, bias drift of the modulator, IQ distortion such as skew between lanes, and narrowbanding in the DAC and ADC. The noise added by signal amplification or the like in the transmission lines 3A to 3F may be estimated by evaluating the noise intensity in the receiving terminal device 40, or may be estimated using an approximate mathematical model assuming that the noise is white Gaussian noise. The distortion compensation control portion 160 of the control device 100 notifies the transmitting terminal device 30 of nonlinear distortion compensation information in the distortion compensation section L1A, and notifies the receiving terminal device 40 of nonlinear distortion compensation information in the distortion compensation section L1B. Based on the notified nonlinear distortion compensation information, the transmitting terminal device 30 and the receiving terminal device 40 each perform distortion compensation processing.

FIG. 20B is a second diagram showing the concept of the control method for the distortion compensation process of the transmitting/receiving terminal device 30 controlled by the distortion compensation control portion 160 of the control device 100. It is assumed that the optical transmission line includes six transmission line sections (3A, 3B, 3C, 3D, 3E, 3F), and that the optical network 51 is composed of five optical signal amplifiers 50 that compensate for the transmission loss in one transmission line section, one optical repeater 200, one transmitting terminal device 30, and one receiving terminal device 40. The optical repeater 200 is located in the front half from the center between transmitting terminal device 30 and the receiving terminal device 40.

For example, assume that the optical repeater 200 is located between the transmission lines 3B and 3C as shown in FIG. 20B. As shown in the first example embodiment, the distortion compensation section determination portion 150 of the control device 100 determines the distortion compensation section of the optical repeater 200 to be 3A to 3D. The distortion compensation control portion 160 of the control device 100 takes into consideration noise originating from the front end in the transmitting terminal device 30, noise originating from the front end in the receiving terminal device 40, and noise added due to signal amplification or the like in the transmission lines 3A to 3F, and determines the distortion compensation section L2A of the transmitting terminal device 30 and the distortion compensation section L2B of the receiving terminal device 40 outside the distortion compensation section of the optical repeater 200 (transmission lines 3E, 3F) so as to maximize the effect of the nonlinear distortion compensation performed by the transmitting terminal device 30 and the receiving terminal device 40. The distortion compensation control portion 160 of the control device 100 notifies the transmitting terminal device 30 of nonlinear distortion compensation information in the distortion compensation section L2A, and notifies the receiving terminal device 40 of nonlinear distortion compensation information in the distortion compensation section L2B. Based on the notified nonlinear distortion compensation information, the transmitting terminal device 30 and the receiving terminal device 40 each perform distortion compensation processing.

This makes it possible to maximize the effect of nonlinear distortion compensation outside the distortion compensation section of the optical repeater 200 by controlling transmission and reception distortion compensation taking into account the accumulated noise along the signal propagation in the optical network 51. Furthermore, by dividing the nonlinear distortion compensation section between the transmitting terminal device 30 and the receiving terminal device 40, it becomes possible to reduce the circuit scale relating to nonlinear distortion compensation in each of the transmitting terminal device 30 and the receiving terminal device 40.

In the above-mentioned processing, the control device 100 may determine the distortion compensation section of the optical repeater 200, and notify at least one of the transmitting terminal device 30 (transmitting device) or the receiving terminal device 40 (receiving device) of nonlinear distortion compensation information to be used for nonlinear distortion compensation in the transmission lines outside the distortion compensation section of the optical repeater 200. Then, at least one of the transmitting terminal device 30 (transmitting device) or the receiving terminal device 40 (receiving device) may generate and send a nonlinear distortion compensated signal based on the nonlinear distortion compensation information obtained from the control device 100, and the optical repeater 200 may perform nonlinear distortion compensation based on the nonlinear distortion compensation information. Nonlinear distortion compensation is performed by either the transmitting terminal device 30 (transmitting device) or the receiving terminal device 40 (receiving device) in a case where the influence of noise generated at either the transmitting terminal device 30 (transmitting device), the receiving terminal device 40 (receiving device), or the transmission line is small. Conversely, in a case where the effect of noise is large at the transmitting terminal device 30 (transmitting device), the receiving terminal device 40 (receiving device), or any point along the transmission line, nonlinear distortion compensation is performed at both the transmitting terminal device 30 (transmitting device) and the receiving terminal device 40 (receiving device).

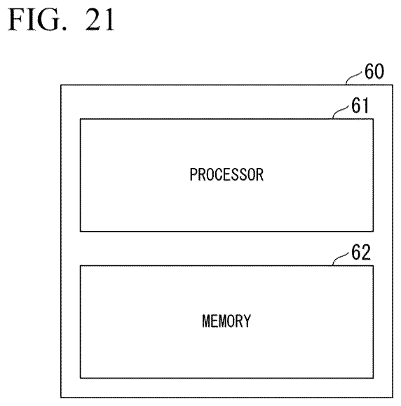

The control device 100, optical repeater 200, transmitting terminal device 30, and receiving terminal device 40 in the above-mentioned example embodiments are configured by hardware or software, or both, and may be configured by a single piece of hardware or software, or may be configured by multiple pieces of hardware or software. Each device (control device, or the like) and each function (processing) may be realized by a computer 60 having a processor 61 such as a CPU (Central Processing Unit) and a memory 62 serving as a storage device, as shown in FIG. 21. For example, a program for carrying out a method (such as a control method) in the example embodiments may be stored in the memory 62, and each function may be realized by executing the program stored in the memory 62 by the processor 61.

These programs include a set of instructions (or software codes) that, in a case where loaded into a computer, cause the computer to perform one or more functions described in the example embodiments. The program may be stored in a non-transitory computer-readable medium or a tangible storage medium. By way of example and not limitation, a computer-readable medium or tangible storage medium includes random-access memory (RAM), read-only memory (ROM), flash memory, a solid-state drive (SSD) or other memory technology, a CD-ROM, a digital versatile disc (DVD), a Blu-ray (registered trademark) discs or other optical disc storage, magnetic cassettes, magnetic tape, magnetic disk storage, or other magnetic storage devices. The program may be transmitted on a transitory computer-readable medium or a communication medium. By way of example, and not limitation, transitory computer-readable media or communication media include electrical, optical, acoustic, or other forms of propagated signals.

Although preferred example embodiments of the control device 100, the optical repeater 200, the transmitting terminal device 30, and the receiving terminal device 40 of this disclosure have been described and illustrated above, this disclosure is not limited to the above-mentioned example embodiments. Additions, omissions, substitutions, and other modifications can be made without departing from the scope of the present disclosure. Moreover, each example embodiment can be appropriately combined with other example embodiments. Accordingly, the disclosure is not to be considered as being limited by the foregoing description, and is only limited by the scope of the appended claims.

Note that some or all of the above-described example embodiments can be described as, but are not limited to, the following supplementary notes.

### (Supplementary Note 1)

An optical network system comprising:
an optical repeater that constitutes an optical network, and a control device that controls the optical repeater,
wherein the control device comprises:
a management means that manages wavelength information of optical signals transmitted and received by the optical repeater in a path of the optical network and transmission line information of an optical transmission line connected to the optical repeater;
a chromatic dispersion compensation control means that determines the amount of chromatic dispersion compensation to be performed in the optical repeater based on the wavelength information and the transmission line information; and
a phase conjugation processing control means that determines phase conjugation processing in the optical repeater based on the wavelength information and the transmission line information,
and
the optical repeater device comprises:
a chromatic dispersion compensation amount acquisition means that acquires the determined chromatic dispersion compensation amount from the control device;
a phase conjugation processing acquisition means that acquires the determined phase conjugation processing information from the control device;
a phase conjugation processing means that, based on the acquired phase conjugation processing information, performs phase conjugation processing on an electrical signal based on a received optical signal; and
a chromatic dispersion compensation means that, based on the acquired chromatic dispersion compensation amount, performs chromatic dispersion compensation processing on an electrical signal based on a received optical signal.

### (Supplementary Note 2)

The optical network system of Supplementary Note 1,
wherein the chromatic dispersion compensation control means calculates an accumulated chromatic dispersion amount in the effective nonlinear distance in the optical transmission line on the receiving side of the optical repeater, and an accumulated chromatic dispersion amount in the effective nonlinear distance in the optical transmission line on the transmitting side of the optical repeater, based on the wavelength information and the transmission line information on the receiving side of the optical repeater and the wavelength information and the transmission line information on the transmitting side of the optical repeater.

### (Supplementary Note 3)

The optical network system of Supplementary Note 2,
the chromatic dispersion compensation control means determines the chromatic dispersion compensation amount based on the accumulated chromatic dispersion amount in the effective nonlinear distance in the optical transmission line on the receiving side of the optical repeater, the accumulated chromatic dispersion amount in the effective nonlinear distance in the optical transmission line on the transmitting side of the optical repeater, and the chromatic dispersion compensation amount obtained by phase conjugation processing in the optical repeater.

### (Supplementary Note 4)

The optical network system according to any one of supplementary notes 1 to 3,
the chromatic dispersion compensation control means determines the chromatic dispersion compensation amount based an accumulated chromatic dispersion amount included in a transmission signal before optical transmission in the optical transmission line on the receiving side of the optical repeater, the accumulated chromatic dispersion amount in the effective nonlinear distance in the optical transmission line on the receiving side of the optical repeater, the accumulated chromatic dispersion amount in the effective nonlinear distance in the optical transmission line on the transmitting side of the optical repeater, and the chromatic dispersion compensation amount obtained by phase conjugation processing in the optical repeater.

### (Supplementary Note 5)

The optical network system according to any one of supplementary notes 1 to 4,
wherein the chromatic dispersion compensation amount is a compensation amount obtained under the condition that the accumulated chromatic dispersion amount in the effective nonlinear distance in the optical transmission line on the receiving side of the optical repeater and the accumulated chromatic dispersion amount in the effective nonlinear distance in the optical transmission line on the transmitting side of the optical repeater have opposite signs.

### (Supplementary Note 6)

The optical network system according to Supplementary Note 1,
wherein in an optical network in which three or more odd number of paths are connected via the optical repeater, the chromatic dispersion compensation control means and the phase conjugation processing control means, based on the wavelength information and the transmission line information in the paths before and after the target optical repeater excluding the optical repeater connected to the last path of the plurality of paths, determine the chromatic dispersion compensation amount and the phase conjugation processing in the target optical repeater.

### (Supplementary Note 7)

The optical network system according to any one of supplementary notes 1 to 6,
wherein the wavelength dispersion compensation control means and the phase conjugation processing control means obtain, in the optical repeater, a combination of two paths, one in the front stage and one in the rear stage, and one optical repeater that relays the paths, and one remaining path, and determine an optical repeater other than the optical repeater connected to the one remaining path as the target optical repeater.

### (Supplementary Note 8)

The optical network system according to Supplementary Note 7,
wherein the phase conjugation processing control means determines the phase conjugation processing to be performed by the optical repeater in the combination.

### (Supplementary Note 9)

The optical network system according to Supplementary Note 7 or 8,
wherein the chromatic dispersion compensation control means determines the chromatic dispersion compensation amount in the optical repeater of the combination based on the wavelength information and the transmission line information in the two optical transmission lines of the combination.

### (Supplementary Note 10)

The optical network system according to Supplementary Note 7,
wherein the chromatic dispersion compensation control means determines the chromatic dispersion compensation amount in the optical repeater of the one remaining path based on the wavelength information and the transmission line information in the optical transmission line of the one remaining path.

### (Supplementary Note 11)

The optical network system according to any one of Supplementary Note 7 to Supplementary Note 10,
wherein the chromatic dispersion compensation amount is a compensation amount obtained under the condition that the amount of accumulated chromatic dispersion in the effective nonlinear distance in the optical transmission line of the remaining one path becomes zero.

### (Supplementary Note 12)

The optical network system according to any one of Supplementary Note 7 to Supplementary Note 11,
wherein in an optical network in which four or more even number of paths are connected via the optical repeater, the chromatic dispersion compensation control means and the phase conjugation processing control means, based on the wavelength information and the transmission line information in the paths before and after each of the optical repeaters in the plurality of paths, determine the chromatic dispersion compensation amount and the phase conjugation processing in the optical repeater.

### (Supplementary Note 13)

The optical network system according to any one of Supplementary Note 1 to Supplementary Note 12,
wherein the chromatic dispersion compensation control means and the phase conjugation processing control means determine a combination of two optical transmission lines and one optical repeater in the optical repeater.

### (Supplementary Note 14)

The optical network system according to any one of Supplementary Note 7 to Supplementary Note 13,
wherein the phase conjugation processing control means determines the phase conjugation processing to be performed in the optical repeater in the combination.

### (Supplementary Note 15)

The optical network system according to any one of Supplementary Note 7 to Supplementary Note 14,
wherein the chromatic dispersion compensation control means determines the chromatic dispersion compensation amount in the optical repeater of the combination based on the wavelength information and the transmission line information in the two optical transmission lines of the combination.

### (Supplementary Note 16)

A control method that
manages wavelength information of optical signals transmitted and received by an optical repeater in an optical network path, transmission line information of an optical transmission line connected to the optical repeater, and the number of paths in the optical network; and
determines the chromatic dispersion compensation amount and phase conjugation processing to be performed in the optical repeater based on the wavelength information and the transmission line information.

### (Supplementary Note 17)

The control method described in Supplementary Note 16, determining the chromatic dispersion compensation amount and phase conjugation processing based on the amount of accumulated chromatic dispersion in the effective nonlinear distance in the optical transmission line on the receiving side of each optical repeater device, and the amount of accumulated chromatic dispersion in the effective nonlinear distance in the optical transmission line on the transmitting side of the optical repeater device in the optical network path.

### (Supplementary Note 18)

A control program that causes a computer to execute processing of
managing wavelength information of optical signals transmitted and received by an optical repeater in a path of an optical network, transmission line information of an optical transmission line connected to the optical repeater, and the number of paths in the optical network; and
determining the chromatic dispersion compensation amount and phase conjugation processing to be performed in the optical repeater based on the wavelength information and the transmission line information.

### (Supplementary Note 19)

The program according to Supplementary Note 18, determining the chromatic dispersion compensation amount and phase conjugation processing based on the amount of accumulated chromatic dispersion in the effective nonlinear distance in the optical transmission line on the receiving side of each optical repeater device, and the amount of accumulated chromatic dispersion in the effective nonlinear distance in the optical transmission line on the transmitting side of the optical repeater device in the optical network path.

### (Supplementary Note 20)

A control device comprising:
a chromatic dispersion compensation control means that determines, in a path of an optical network, the amount of chromatic dispersion compensation to be performed in an optical repeater constituting the optical network based on wavelength information of optical signals transmitted and received by the optical repeater and transmission line information of an optical transmission line connected to the optical repeater; and
a phase conjugation processing control means that determines phase conjugation processing in the optical repeater based on the wavelength information and the transmission line information.

### (Supplementary Note 21)

The control device according to Supplementary Note 20, wherein the phase conjugation processing control means transmits to the optical repeater an instruction to perform phase conjugation processing for calculating a complex conjugation of the optical signal.

### (Supplementary Note 22)

The control device according to Supplementary Note 21, wherein the chromatic dispersion compensation control means
calculates a first accumulated chromatic dispersion amount in a first effective nonlinear distance based on a transmission-side network device in a first optical transmission line with the transmission-side network device, which transmits an optical signal received by the optical repeater, among the optical transmission lines to which the optical repeater is connected;
calculates a second accumulated chromatic dispersion amount, having the opposite sign to the first accumulated chromatic dispersion amount, in a second effective nonlinear distance based on the device itself of the optical signal in a second optical transmission line with the reception-side network device of the optical signal transmitted by the optical repeater, among the optical transmission lines to which the optical repeater is connected to; and
calculates, based on a statistical value of a transition in the accumulated chromatic dispersion amount of the optical signal according to the distance in the second optical transmission line the chromatic dispersion compensation amount indicating the difference between a chromatic dispersion amount during transmission in the optical repeater of the optical signal in a case where the accumulated chromatic dispersion amount of the optical signal in the second effective nonlinear distance becomes the second accumulated chromatic dispersion amount, and the chromatic dispersion amount that is the result of the complex conjugation.

### (Supplementary Note 23)

An optical repeater device indicating the device itself communicatively connected with a control device comprising:
a chromatic dispersion compensation control means that determines, in a path of an optical network, the amount of chromatic dispersion compensation to be performed in the device itself based on wavelength information of optical signals transmitted and received by the device itself constituting the optical network and transmission line information of an optical transmission line connected to the device itself; and
a phase conjugation processing control means that determines phase conjugation processing in the device itself based on the wavelength information and the transmission line information,
the optical repeater comprising:
a phase conjugation processing means that, based on acquired phase conjugation processing information acquired from the control device, performs phase conjugation processing on an electrical signal based on a received optical signal; and
a chromatic dispersion compensation means that, based on the chromatic dispersion compensation amount, performs chromatic dispersion compensation processing on an electrical signal based on a received optical signal.

### (Supplementary Note 24)

The optical repeater according to Supplementary Note 23,
wherein the phase conjugation processing means performs phase conjugation processing based on an instruction to perform phase conjugate processing in order to calculate the complex conjugate of the optical signal.

### (Supplementary Note 25)

The optical repeater according to Supplementary Note 24, comprising a chromatic dispersion compensation means that:
calculates a first accumulated chromatic dispersion amount in a first effective nonlinear distance based on a transmission-side network device in a first optical transmission line with the transmission-side network device, which transmits an optical signal received by the optical repeater, among the optical transmission lines to which the optical repeater is connected;
calculates a second accumulated chromatic dispersion amount, having the opposite sign to the first accumulated chromatic dispersion amount, in a second effective nonlinear distance based on the device itself of the optical signal in a second optical transmission line with the reception-side network device of the optical signal transmitted by the optical repeater, among the optical transmission lines to which the optical repeater is connected to;
communicatively connects with control that calculates, based on a statistical value of a transition in the accumulated chromatic dispersion amount of the optical signal according to the distance in the second optical transmission line the chromatic dispersion compensation amount indicating the difference between a chromatic dispersion amount during transmission in the optical repeater of the optical signal in a case where the accumulated chromatic dispersion amount of the optical signal in the second effective nonlinear distance becomes the second accumulated chromatic dispersion amount, and the chromatic dispersion amount that is the result of the complex conjugation; and
determines, after the phase conjugation processing, a chromatic dispersion amount of an optical signal to be transmitted to the reception-side network device based on a chromatic dispersion amount that is a result of the complex conjugation and chromatic dispersion compensation amount acquired from the control device.

### (Supplementary Note 26)

An optical repeater comprising:
a digital signal processing means that performs frequency flip processing on at least one or more channels of an optical signal on a channel-by-channel basis.

### (Supplementary Note 27)

The optical repeater according to Supplementary Note 26, wherein the digital signal processing means performs the frequency flip processing on all channels of the optical signal on a channel-by-channel basis.

### (Supplementary Note 28)

The optical repeater according to Supplementary Note 26 or Supplementary Note 27, wherein the digital signal processing means sequentially identifies processing targets and non-processing targets among the plurality of channels with different frequency bands arranged in order based on the frequency bands, and performs the frequency flip processing on the channels identified as processing targets.

### (Supplementary Note 29)

The optical repeater according to any one of supplementary notes 26 to 28, wherein digital signal processing means performs the frequency flip processing to invert the frequency component of the optical signal for each frequency based on a reference frequency set at the center of the frequency band.

### (Supplementary Note 30)

The optical repeater according to any one of supplementary notes 26 to 29, wherein the digital signal processing means comprises:
a phase conjugation processing means that performs phase conjugation processing on an electrical signal based on a received optical signal;
a chromatic dispersion compensation means that performs chromatic dispersion compensation processing on an electrical signal based on the received optical signal; and
a frequency flip processing means that performs the frequency flip processing.

### (Supplementary Note 31)

The optical repeater according to any one of Supplementary Note 26 to Supplementary Note 30, wherein the frequency flip processing means performs the phase conjugation processing and the chromatic dispersion compensation processing for all channels of the optical signal, and performs the frequency flip processing on at least one or more channels on a channel-by-channel basis.

### (Supplementary Note 32)

An optical repeater comprising:
a chromatic dispersion compensation processing means that performs chromatic dispersion compensation processing on an electrical signal based on a received optical signal, based on a carrier frequency and a frequency band of a corresponding channel among a plurality of channels included in the optical signal; and
a phase conjugation processing means that performs phase conjugation processing on an electrical signal based on the received optical signal.

### (Supplementary Note 33)

The optical repeater according to Supplementary Note 32, wherein the chromatic dispersion compensation processing means performs chromatic dispersion compensation processing based on a frequency region of the relevant channel among the frequency bands of all the channels of the plurality of channels having different frequency bands.

### (Supplementary Note 34)

The optical repeater according to Supplementary Note 32 or Supplementary Note 33, wherein the chromatic dispersion compensation processing means performs chromatic dispersion compensation processing based on a frequency region of the relevant channel among the frequency bands of all the channels of the plurality of channels having different frequency bands, after or before the phase conjugation processing.

### (Supplementary Note 35)

The optical repeater according to any one of supplementary notes 32 to 34, wherein a carrier frequency control means that performs carrier frequency control for changing the frequencies of a plurality of channels included in the optical signal.

### (Supplementary Note 36)

The optical repeater according to Supplementary Note 35, wherein the carrier frequency control means identifies the order of the plurality of channels arranged in order based on the frequency band among the plurality of channels having different frequency bands, and determines the carrier frequency at the time of transmission of the plurality of channels such that the order of the channels is reversed.

### (Supplementary Note 37)

The optical repeater according to Supplementary Note 35 or Supplementary Note 36, wherein the carrier frequency control means identifies the order of the plurality of channels arranged in order based on the frequency band among the plurality of channels having different frequency bands, determines the carrier frequency at the time of transmission of the plurality of channels such that the order of the channels is reversed, and provides a certain frequency offset to each of the channels.

### (Supplementary Note 38)

An optical repeating method that performs chromatic dispersion compensation processing on an electrical signal based on a received optical signal based on the carrier frequency and frequency band of a corresponding channel among a plurality of channels contained in the optical signal, and performs phase conjugation processing on the electrical signal based on the received optical signal.

### (Supplementary Note 39)

The optical repeating method as described in Supplementary Note 38, performing carrier frequency control to change the frequencies of multiple channels contained in the optical signal.

### (Supplementary Note 40)

The optical repeating method according to Supplementary Note 38 or Supplementary Note 39, performing the chromatic dispersion compensation processing based on a frequency region of the relevant channel among the frequency bands of all the channels of the plurality of channels having different frequency bands.

### (Supplementary Note 41)

The optical repeating method according to any one of Supplementary Note 38 to Supplementary Note 40, performing the chromatic dispersion compensation processing based on a frequency region of the relevant channel among the frequency bands of all the channels of the plurality of channels having different frequency bands, after or before the phase conjugation processing.

### (Supplementary Note 42)

The optical repeating method according to any one of Supplementary Note 38 to Supplementary Note 41, identifying the order of the plurality of channels arranged in order based on the frequency band among the plurality of channels having different frequency bands, and determining the carrier frequency at the time of transmission of the plurality of channels such that the order of the channels is reversed.

### (Supplementary Note 43)

The optical repeating method according to any one of Supplementary Note 38 to Supplementary Note 42, identifying the order of the plurality of channels arranged in order based on the frequency band among the plurality of channels having different frequency bands, determining the carrier frequency at the time of transmission of the plurality of channels such that the order of the channels is reversed, and providing a certain frequency offset to each of the channels.

### (Supplementary Note 44)

A program that causes an optical repeater to function as
a chromatic dispersion compensation processing means that performs chromatic dispersion compensation processing on an electrical signal based on a received optical signal, based on a carrier frequency and a frequency band of a corresponding channel among a plurality of channels included in the optical signal; and
a phase conjugation processing means that performs phase conjugation processing on an electrical signal based on the received optical signal.

### (Supplementary Note 45)

The program according to Supplementary Note 44 for causing an optical repeater to function as a carrier frequency control means that performs carrier frequency control for changing the frequencies of a plurality of channels included in the optical signal.

### (Supplementary Note 46)

The program according to Supplementary Note 44 or Supplementary Note 45, wherein the chromatic dispersion compensation processing means performs chromatic dispersion compensation processing based on a frequency region of the relevant channel among the frequency bands of all the channels of the plurality of channels having different frequency bands.

### (Supplementary Note 47)

The program according to any one of Supplementary Note 44 to Supplementary Note 46, wherein the chromatic dispersion compensation processing means performs chromatic dispersion compensation processing based on a frequency region of the relevant channel among the frequency bands of all the channels of the plurality of channels having different frequency bands, after or before the phase conjugation processing.

### (Supplementary Note 48)

The program according to Supplementary Note 45, wherein the carrier frequency control means identifies the order of the plurality of channels arranged in order based on the frequency band among the plurality of channels having different frequency bands, and determines the carrier frequency at the time of transmission of the plurality of channels such that the order of the channels is reversed.

### (Supplementary Note 49)

The program according to Supplementary Note 45 or Supplementary Note 48, wherein the carrier frequency control means identifies the order of the plurality of channels arranged in order based on the frequency band among the plurality of channels having different frequency bands, determines the carrier frequency at the time of transmission of the plurality of channels such that the order of the channels is reversed, and provides a certain frequency offset to each of the channels.

### (Supplementary Note 50)

An optical network system comprising:
a transmitting device provided with a first nonlinear distortion compensation portion;
a receiving device provided with a second nonlinear distortion compensation portion;
one or more optical repeaters having a third nonlinear distortion compensation portion;
an optical transmission line connecting the transmitting device, the optical repeater, and the receiving device; and
a control device that controls the transmitting device, the receiving device, and the optical repeater.

### (Supplementary Note 51)

The optical network system according to Supplementary Note 50, wherein the control device determines a distortion compensation section of the optical repeater in a transmission line in which the optical repeater performs nonlinear distortion compensation.

### (Supplementary Note 52)

The optical network system according to Supplementary Note 51, wherein the control device transmits nonlinear distortion compensation information to be used for the nonlinear distortion compensation to the transmitting device or the receiving device according to the position of the distortion compensation section of the optical repeater with respect to the optical transmission line.

### (Supplementary Note 53)

The optical network system according to Supplementary Note 52, wherein the control device,
in a case where the distortion compensation section of the optical repeater is located in the latter half of the transmission path, notifies the transmitting device of nonlinear distortion compensation information to be used for nonlinear distortion compensation for the transmission path outside the distortion compensation section of the optical repeater; and
in a case where the distortion compensation section of the optical repeater is located in the first half of the transmission path, notifies the receiving device of nonlinear distortion compensation information to be used for nonlinear distortion compensation in the transmission line outside the distortion compensation section of the optical repeater.

### (Supplementary Note 54)

The optical network system according to Supplementary Note 53, wherein the control device,
based on signal noise originating from the transmitting device, signal noise originating from the receiving device, and noise added in the transmission line, determines a distortion compensation section in which the transmitting device performs nonlinear distortion compensation and a distortion compensation section in which the receiving device performs nonlinear distortion compensation for a transmission line section outside the distortion compensation section of the optical repeater.

### (Supplementary Note 55)

The optical network system according to Supplementary Note 54, wherein the control device notifies the transmitting device or the receiving device of nonlinear distortion compensation information to be used in the nonlinear distortion compensation process performed by the transmitting device or the receiving device based on the distortion compensation section of the transmitting device and the distortion compensation section of the receiving device.

### (Supplementary Note 56)

A control method wherein in an optical network system comprising:
a transmitting device provided with a first nonlinear distortion compensation portion;
a receiving device provided with a second nonlinear distortion compensation portion;
one or more optical repeaters having a third nonlinear distortion compensation portion;
an optical transmission line connecting the transmitting device, the optical repeater, and the receiving device; and
a control device that controls the transmitting device, the receiving device, and the optical repeater,
the control device determines a distortion compensation section of the optical repeater, and notifies at least one of the transmitting device and the receiving device of nonlinear distortion compensation information to be used for nonlinear distortion compensation in a transmission line outside the distortion compensation section of the optical repeater;
at least one of the transmitting device and the receiving device generates and sends a nonlinear distortion compensated signal based on the nonlinear distortion compensation information; and
the optical repeater performs nonlinear distortion compensation based on the nonlinear distortion compensation information.

### (Supplementary Note 57)

A program that executes a process wherein, in an optical network system comprising:
a transmitting device provided with a first nonlinear distortion compensation portion;
a receiving device provided with a second nonlinear distortion compensation portion;
one or more optical repeaters having a third nonlinear distortion compensation portion;
an optical transmission line connecting the transmitting device, the optical repeater, and the receiving device; and
a control device that controls the transmitting device, the receiving device, and the optical repeater,
the control device determines a distortion compensation section of the optical repeater, and notifies at least one of the transmitting device and the receiving device of nonlinear distortion compensation information to be used for nonlinear distortion compensation in a transmission line outside the distortion compensation section of the optical repeater.

What is claimed is:

1. An optical network system comprising:
a transmitter configured to compensate a first nonlinear distortion;
a receiver configured to compensate a second nonlinear distortion;
one or more optical repeaters configured to compensate a third nonlinear distortion;
an optical transmission line connecting the transmitter, the optical repeater, and the receiver;
a controller configured to control the transmitter, the receiver, and the optical repeater;
at least one memory configured to store instructions; and
at least one processor configured to execute the instructions to
determine a distortion compensation section of the optical repeater in a transmission line in which the optical repeater performs nonlinear distortion compensation.

2. The optical network system according to claim 1,
wherein the at least one processor is configured to transmit nonlinear distortion compensation information to be used for the nonlinear distortion compensation to the transmitter or the receiver according to a position of the distortion compensation section of the optical repeater with respect to the optical transmission line.

3. The optical network system according to claim 2,
wherein the at least one processor is configured to notify,
in a case where the distortion compensation section of the optical repeater is located in the latter half of the transmission path, the transmitter of nonlinear distortion compensation information to be used for the nonlinear distortion compensation for the transmission path outside the distortion compensation section of the optical repeater; and
in a case where the distortion compensation section of the optical repeater is located in the first half of the transmission path, notify the receiver of nonlinear distortion compensation information to be used for the nonlinear distortion compensation in the transmission line outside the distortion compensation section of the optical repeater.

4. The optical network system according to claim 3,
wherein the at least one processor is configured to determine, based on signal noise originating from the transmitter, signal noise originating from the receiver, and noise added in the transmission line, a distortion compensation section in which the transmitter performs the nonlinear distortion compensation and a distortion compensation section in which the receiver performs the nonlinear distortion compensation for a transmission line section outside the distortion compensation section of the optical repeater.

5. The optical network system according to claim 4,
wherein the at least one processor is configured to notify the transmitter or the receiver of the nonlinear distortion compensation information to be used in the nonlinear distortion compensation process performed by the transmitter or the receiver based on the distortion compensation section of the transmitter and the distortion compensation section of the receiver.

6. A control method executed by an optical network system comprising:
a transmitter configured to compensate a first nonlinear distortion;
a receiver configured to compensate a second nonlinear distortion;
one or more optical repeaters configured to compensate a third nonlinear distortion;
an optical transmission line connecting the transmitter, the optical repeater, and the receiver; and
a controller configured to control the transmitter, the receiver, and the optical repeater, the method comprising:
determining a distortion compensation section of the optical repeater;
notifying at least one of the transmitter and the receiver of nonlinear distortion compensation information to be used for nonlinear distortion compensation in a transmission line outside the distortion compensation section of the optical repeater;
generating and sending, by at least one of the transmitter and the receiver, a nonlinear distortion compensated signal based on the nonlinear distortion compensation information; and
performing, by the optical repeater, nonlinear distortion compensation based on the nonlinear distortion compensation information.

7. A non-transitory storage medium storing a program, a computer of an optical network system comprising:
a transmitter configured to compensate a first nonlinear distortion;
a receiver configured to compensate a second nonlinear distortion;
one or more optical repeaters configured to compensate a third nonlinear distortion;
an optical transmission line connecting the transmitter, the optical repeater, and the receiver; and
a controller configured to control the transmitter, the receiver, and the optical repeater,
wherein the program causes the computer to execute:
determining a distortion compensation section of the optical repeater; and
notifying at least one of the transmitter and the receiver of nonlinear distortion compensation information to be used for nonlinear distortion compensation in a transmission line outside the distortion compensation section of the optical repeater.
